(19) United States
(12) Patent Application Publication
(10) Pub. No.: US 2015/0073955 A1
(43) Pub. Date: Mar. 12, 2015

(54) MANAGEMENT INTERFACE FOR BUSINESS MANAGEMENT APPLICATIONS

(71) Applicant: Jonathan A. Gilman, Chicago, IL (US)

(72) Inventor: Jonathan A. Gilman, Chicago, IL (US)

(21) Appl. No.: 14/025,481

(22) Filed: Sep. 12, 2013

(51) Int. Cl. G06Q 30/04

(52) U.S. Cl. CPC G06Q 30/04
USPC 705/34

(57) ABSTRACT

According to some aspects, a method of providing access to and presenting information from a third-party business management software system, the third-party business management software system comprising a database storing customer data for a plurality of customers is provided. The method comprises providing an interface for display on a user computer, the interface accessible via an internet browser coupled to a network, receiving input from a user via the interface identifying a customer from the plurality of customers, responsive to the input from the user, accessing the third-party business management software system to obtain customer data associated with the identified customer, and presenting the customer data to the user via the interface in a single view. Some aspects include a system comprising at least one application computer for performing the above method.

### BACKGROUND

Business management applications are frequently utilized by an enterprise, business or organization in a wide variety of circumstances to facilitate improved operation of the business. For example, some business management applications include or correspond to a customer management application employed in an enterprise environment to automate functions such as invoicing, collections, payment disbursements and/or to manage generally high volume billing tasks for which large numbers of transactions may be handled automatically. A customer management application refers generally to any enterprise application adapted to manage multiple (typically numerous) customer accounts and store customer data associated with the respective customer accounts.

Access to customer data handled by a customer management application may be needed to assist in managing customer accounts and/or maintaining correct operation of underlying business processes. For example, while a customer management application is typically configured to automate substantial functionality (e.g., automate routine tasks associated with the customer accounts), operator access is typically necessary on a relatively frequent basis to inspect and/or manipulate customer data, identify and correct errors, add new customers and/or add new contracts, documents or policies in connection with an existing customer(s), edit customer data, update one or more customer accounts, manually conduct one or more transactions and/or otherwise manually intervene to correctly manage customer accounts.

Accomplishing such tasks manually using conventional customer management applications is frequently complicated, time consuming and unintuitive. As a result, it is frequently the case that only specially trained personnel are equipped with the know-how to perform such manual tasks. Moreover, even such trained personnel are still required to perform numerous steps to complete manual tasks, some of which may need to be performed daily, repeatedly on a daily basis and/or at a volume significant enough that conventional approaches are unsatisfactory. As such, manual intervention in conventional customer management applications is typically a time consuming, resource intensive and costly undertaking.

The general difficulty in performing tasks manually in connection with conventional customer management applications stems, at least in part, to generally poor interface functionality. However, it may be costly for an enterprise or organization to improve these interfaces due to widespread institutional use within the business. Performing an upgrade may consequently be a significant and expensive undertaking, frequently requiring substantial user training to learn how to use the upgraded software. Some customer management application interfaces are tailored for the needs of a particular organization, but such customization involves significant effort and expense to implement the organization's particular business needs. Implementation of a customized solution may be substantially disruptive to the organization, including downtime for training needs, etc. Moreover, the narrow applicability of such custom solutions may be such that the benefit justifies the cost in limited circumstances only.

### SUMMARY

Some embodiments include a method of providing access to and presenting information from a third-party business management software system, the third-party business management software system comprising a database storing customer data for a plurality of customers. The method may comprise providing an interface for display on a user computer, the interface accessible via an internet browser coupled to a network, receiving input from a user via the interface identifying a customer from the plurality of customers, responsive to the input from the user, accessing the third-party business management software system to obtain customer data associated with the identified customer, and presenting the customer data to the user via the interface in a single view.

Some embodiments include a system for providing access to and presenting information from a third-party business management software system on a user computer connected to a network, the third-party business management software system comprising a database storing customer data for a plurality of customers. The system may comprise at least one application computer capable of communicating with the user computer over the network, the at least one application computer executing an application configured to communicate with the third-party business management software system, the application, when executed by the at least one application computer, causing the at least one application computer to perform providing an interface for display on the user computer, the interface accessible via an internet browser coupled to the network, receiving input from the user via the interface identifying a customer from the plurality of customers, responsive to the input from the user, accessing the third-party business management software system to obtain customer data associated with the identified customer, and presenting the customer data to the user via the interface in a single view.

### BRIEF DESCRIPTION OF DRAWINGS

The accompanying drawings are not intended to be drawn to scale. In the drawings, for purposes of clarity, not every component may be labeled in every drawing. In the drawings:

FIG. 1 depicts a schematic view of a system suitable for practicing management interface techniques according to some embodiments;

FIG. 2 illustrates a method of providing a management interface, in accordance with some embodiments;

FIG. 3 depicts a block diagram of a system suitable for practicing management interface techniques according to some embodiments;

FIGS. 4A and 4B depict block diagrams of other systems suitable for practicing management interface techniques according to some embodiments;

FIG. 5 depicts a schematic view of an exemplary system generating a management interface and utilizing SAP, according to some embodiments;

FIG. 6 illustrates a single view of a management interface, according to some embodiments;

FIGS. 7A-I show a series of screen shots of an exemplary management interface, according to some embodiments;

FIG. 8 is a schematic view of a computer system on which techniques described herein may be implemented; and

FIG. 9A-9G illustrate exemplary processes that may be performed in connection with the exemplary process links illustrated in FIG. 7A, in accordance with some embodiments.

### DETAILED DESCRIPTION

As discussed above, conventional business management applications (e.g., customer management applications and/or business management solutions that include customer management functionality) are often difficult to use, lack intuitiveness and/or are equipped with interface functionality that makes it difficult and time-consuming to access data, identify issues, correct problems, manipulate data (e.g., add, delete or edit the data or relationships among the data) and/or otherwise manually intervene to perform one or more operator driven tasks.

For example, conventional business/customer management interface functionality is not well designed to facilitate performing any particular task or process or to assist a user in achieving a particular goal. As a result, performing a desired task often requires numerous screens to be opened to load and access the data needed to perform the desired task. Additionally, what screens need to be accessed, how to access them, and in what order is often not intuitive and may require extensive training and/or experience to understand the appropriate sequence of actions necessary to perform a desired task. Moreover, even after the requisite know-how has been acquired, such tasks remain relatively time consuming to perform using conventional interfaces, resulting in highs costs associated with manually interacting with the business management application.

The inventor has appreciated that improved operator interaction with a business management application (e.g., a customer management application, or a business management application that includes customer management functionality) may be facilitated by providing a convenient and efficient interface to the business management application. An interface refers to one or more software elements that facilitate interaction with a user, typically by providing mechanisms that allow a user to provide input and mechanisms that allow information to be rendered to the user. A management interface refers to an interface incorporating one or more techniques described herein. According to some embodiments, a management interface to a business management application may be process-oriented by providing functionality and presenting data in a manner that facilitates a user performing one or more tasks. Such a process-oriented approach may provide a more intuitive interface that can be utilized to access and manipulate data quickly and efficiently and potentially with relatively little or no training.

According to some embodiments, a management interface is provided that allows access to customer data associated with a plurality of customer accounts managed by a business management application, wherein the management interface provides the necessary data and/or functionality to perform one or more tasks within a single view of the management interface. The term “view” refers herein to a presentation of a collection of data (e.g., customer data) obtained from a business management application that, once the collection of data is obtained via one or more queries, accesses and/or exchanges with the business management software, no further accesses to the business management software is required to obtain further data for the corresponding view. In this respect, a view is a generally self-contained instance of data obtained from a business management application and the associated interface elements employed to present the obtained data.

As discussed in further detail below, a single view may organize the corresponding collection of data such that some portion of the collection of the data is visible while some portion of the collection of data may be hidden, the latter of which can be made visible via interaction with one or more interface elements included in the view. For example, a view may be comprised of a plurality of tabs wherein when each tab is selected, a corresponding portion of the collection of data of the view is made visible. Any number or type of interface elements may be utilized (e.g., windows, menus, tabs, buttons, etc.) to organize the collection of data as desired, as a view is not limited in this respect. After the collection of data is obtained and a view presented, presentation of data obtained via further accesses to the business management application are considered to be part of a separate view.

As a result of consolidating obtained customer data in a single view, a task or series of tasks may be performed while minimizing the number of times the management interface requests customer data from the database associated with the business or customer management application, minimizing the number of screens that need to be accessed and/or minimizing the number of actions required to perform the task or series of tasks. Providing such functionality within a single view of a management interface may result in the management interface being more efficient than a conventional interface that provides data and/or functionality for a common task within multiple (often numerous) views, since the latter requires multiple requests to a business management application during the course of a user performing the task. Moreover, since the management interface consolidates the needed customer data and/or functionality within a single view, the customer data and/or functionality can be presented to the user in an intuitive manner that is oriented to performing the one or more tasks associated with the view.

As discussed above, a significant obstacle for an enterprise, business or organization in adopting a different interface to a business management application is that doing so typically involves either adopting a different business management application or developing customized interfaces to the existing business management application, both solutions of which are disruptive, costly and time consuming. Moreover, an enterprise may be reluctant to adopt a new interface due to the training involved in bringing personnel up to speed on the use of the interface. Furthermore, a new interface may require the software modules that, when executed, provide the interface may need to be installed at numerous locations where personnel require access.

The inventor has developed techniques that allow one or more management interfaces to be integrated with an existing business management application and, in some embodiments, with little or no modification to the business management application. As such, the potential impact to an organization choosing to implement such an interface may be minimized by exploiting a previously deployed enterprise solution. The inventor has appreciated that implementing a management interface using web technology facilitates a deployment that may only require appropriate personnel to have access to an internet-browser. Moreover, using familiar browser-based technology may reduce the amount of training required to get personnel comfortable with the new interface as many existing and new users are likely well accustomed to using browser-based interfaces, thereby further reducing the impact to the organization in implementing such a solution.

According to some embodiments, a management interface for a third-party business management application (e.g., an existing and deployed customer management application) may be implemented as a cloud-based application (e.g., operating on an application server) accessible over one or more networks (e.g., the Internet), wherein the management interface is presented via a browser on a client computer connected to the one or more networks. In this way, the management interface may be accessed simply by supplying the browser with the uniform resource locator (URL) to the cloud-based application. As a result, personnel can access the management interface using a browser without the need for special installment procedures or complicated deployment strategies.

The inventor has further appreciated that adoption of a management interface to a business management application may be facilitated by reducing the amount of and/or eliminating modifications to the business management application needed to deploy the management interface. According to some embodiments, a cloud-based application accesses a third-party customer management application using existing application programming interfaces (APIs) exposed by the third-party business management application, thereby enabling access to the customer data without needing to modify the business management application. In this manner, a management interface to a third-party business management application may be deployed with minimal or no modification to the third-party customer management application.

The inventor has recognized that adopting a management interface that provides access to a third-party business management application may be made more attractive by lessening the burden of deploying the management interface to provide a more seamless integration with the third-party customer management application in other ways. For example, some embodiments of a management interface make use of the same security model as the business management application, allowing an organization to use the same usernames and passwords to access data via the management interface as are used when interfacing with the business management application directly. According to some embodiments, the management interface requests access information (e.g., username and password) from an operator and authenticates the received access information against those utilized by the business management application. As a result, an operator, once authenticated, will enjoy the same access privileges via the management interface as those authorized by the third-party business management application.

Further benefits may be derived from embodiments that employ a cloud-based management interface application, including a management interface that can be modified independently of the business management application such that interface functionality may be modified, changed or updated without impacting the business management application (e.g., without needing to install an update or reconfigure the business management application. Such embodiments may allow modifications to the experience a user has interacting (e.g., accessing and/or performing actions) with the management interface without making substantial changes (or making no changes) to the business management application itself. Additionally, a cloud-based solution may utilize computing resources (e.g., resources on the application server providing the management interface, resources on the client computer on which the browser executes, etc.) different from those used by the business management application, improving the user experience by allowing data retrieval and rendering processing to be performed in parallel.

Some techniques described herein facilitate asynchronous communication between a management interface and the business management application. According to some embodiments, the management interface is implemented separately from the business management application so that the management interface may make requests to the business management application without interrupting interaction with the interface while request(s) is/are pending. Asynchronous requests may be made independent of user actions (e.g., automated requests to generate a cache of customer data from the business management application), and/or based on or responsive to user actions (e.g., retrieving results of a search initiated by the user), as discussed in further detail below.

Following below are more detailed descriptions of various concepts related to, and embodiments of, a management interface for business management applications. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

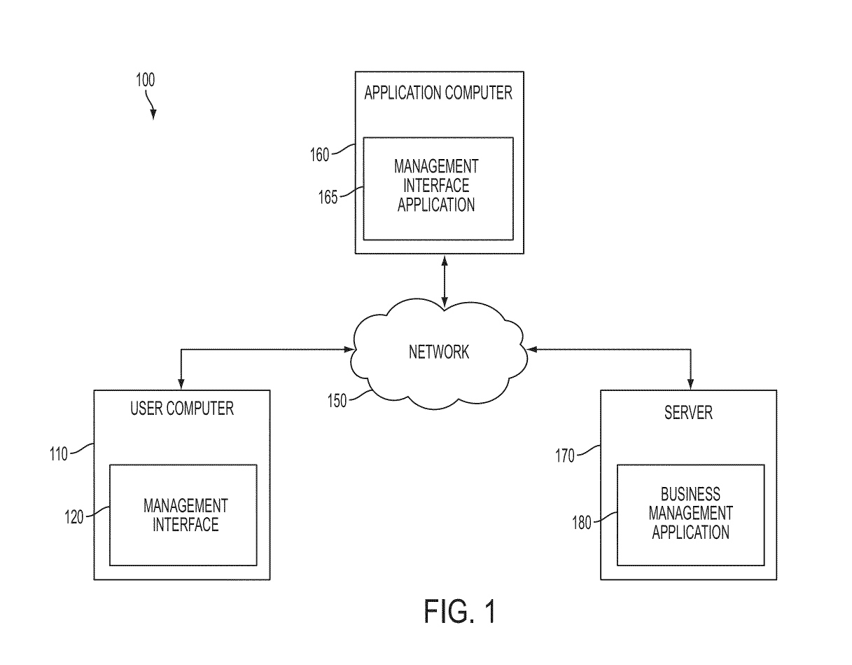

FIG. 1 schematically depicts a system 100 on which a management interface to a business management application may be implemented, in accordance with some embodiments. System 100 comprises a user computer 110 capable of rendering management interface 120 to a user, for example, via an internet browser; a server 170 configured to execute a business management application 180; and/or an application computer 160 configured to execute a management interface application 165 capable of accessing business management application 180 and providing management interface 120 to be presented to the user on user computer 110. The above described components may be connected to network 150, which may comprise one or more networks including one or any combination of a wide area network (WAN) such as the Internet, one or more local area networks (LANs), one or more private networks and/or one or more other types of suitable networks providing device connectivity. The above described components and their operation are each described in further detail below.

As discussed above, application computer 160 may be configured to execute a management interface application 165 programmed to access business management application 180 (e.g., a customer management application or a business management application having a customer management component or that comprises customer management functionality) to request customer data associated with a plurality of customer accounts managed by business management application 180. Based at least in part on customer data obtained from business management application 180, management interface application 165 produces management interface data to be presented as management interface 120 on user computer 110.

The content of management interface 120 may therefore be based, at least in part, upon user input received via management interface 120. For example, user input provided to user computer 110 may be communicated to application computer 160 via network 150. The user input may then be processed by management interface application 165 to provide and/or update management interface 120 in response. Additionally, management interface application 165 may also receive user input via management interface 120 and, in response, apply data to, initiate one or more transactions and/or perform one or more functions associated with business management application 180, as discussed in further detail below.

Application computer 160 may include any suitable computing device or devices capable of sending and/or receiving data via network 150, and executing management interface application 165. For example, application computer 160 may be a web server such that management interface 165 may be accessed via the web (e.g., via a Uniform Resource Located (URL)) to provide a web interface to user computer 110 and receive user input provided by a user via the web interface. In this respect, management interface application 165 may be implemented in the “cloud” with the functionality provided by the application accessible using standard web-based or Internet-based technology (e.g., a web or internet browser executing on user computer 110). Application computer 160 may communicate via network 150 utilizing any suitable wired and/or wireless technology and using any suitable network protocol, as the techniques described herein are not limited for use with any particular configuration or implementation.

User computer 110 may comprise any suitable computing device or devices capable of presenting management interface 120 to one or more users based on management interface data received from application computer 160 via network 150, and capable of providing user input received via management interface 120 to network 150. For example, user computer 110 may be a personal computer, user terminal, mobile device, etc., and management interface 120 may comprise a web interface (e.g., accessed via browser software executed by user computer 110). User computer 110 is capable of accessing network 150 which, as described above, may comprise any suitable network, or combination of networks, including an intranet and/or the Internet. User computer 110 may be coupled to network 150 via any suitable wired and/or wireless communication technology, including but not limited to IEEE 802.3 (Ethernet), USB, Firewire, Bluetooth, IEEE 802.11 (Wi-Fi), infrared, cellular, radio, and/or any combination thereof, and may communicate with network 150 using any suitable protocol.

As discussed above, server 170 includes business management application 180. Server 170 may include any suitable computing device or devices capable of sending and/or receiving data via network 150, and capable of executing business management application 180. Business management application 180 may include any combination of hardware and/or software with business and/or customer management functionality, including, but not limited to, customer relationship management (CRM) applications, billing and disbursement applications, data warehousing applications, enterprise reporting applications, metadata management applications, business intelligence applications, and/or any combinations thereof.

In some embodiments, business management application 180 includes, and/or is coupled to, a database that stores business and/or customer data. For example, business management application 180 may manage multiple (often numerous) customer accounts wherein the customer data is stored and is accessible via the database. The database may include any suitable combination of hardware and/or software for storing data, organizing data, and/or providing data in response to queries, and may, for example, include a relational database, object database, navigational database, document oriented database, hierarchical database, star schema database, etc. Alternatively or additionally, a database may include one or more database management systems (DBMSs) including, but not limited to, Oracle, Sybase, IBM DB2, Informix, Neteeza, SQL Server, MySQL, Teradata, Microsoft Access, dBASE, and/or any combinations thereof.

Business management application 180 may be any suitable enterprise application for which management interface functionality is desirable. According to some embodiments, business management application 180 is a third-party business management application employed by an enterprise or organization to manage business processes associated with the enterprise. For example, business management application 180 may be any of a variety of conventional business management applications that natively provide generally complicated, difficult, and/or unintuitive interface functionality to the underlying business management functionality provided by the business management application.

Management interface application 165 may be programmed to access business management application 180 to obtain data therefrom (e.g., customer data associated with one or more customer accounts managed by the business management application) and provide the data along with interface functionality to user computer 110 for presentation as management interface 120. Additionally, management interface application 165 may be programmed to provide data to business management application 180 (e.g., responsive to or independent of user input), including new or modified business and/or customer data to be applied to a database, as well as data to initiate one or more transactions, enact one or more functions, or otherwise utilize business management application functionality.

As discussed in further detail below, management interface application 165 may act to transform or otherwise translate data received by user computer 110 or server 170 (e.g., from business management application 180) and/or perform subsequent processing based on the data. For example, input provided via management interface 120 may indicate a request for data from the business management application 180 and management interface application 165 may generate a request to business management application 180 based on the input received from the user via the management interface. Alternatively, or additionally, data provided by business management application 180 may be formatted and/or transformed by application 160 in order to be presented as desired via management interface 120.

Additionally, as management interface 120 may be adapted to facilitate manual interaction with business management application 180, user input relating to adding, deleting, updating, editing or otherwise modifying customer data associated with the business management application, initiating one or more transactions associated with the customer data and/or otherwise performing one or more functions associated with the customer data may be applied via management interface application 165. For example, management interface application 165 may provide data corresponding to user input to business management application 180 to modify the content of one or more databases associated with the business management application, to perform operations on the customer data, to initiate actions in association with the customer data, or to otherwise perform one or more functions associated with the business management application.

In this manner, management interface application 165 may be configured to exchange data with business management application 180 to request data from, apply data to and perform functions associated with the business management application. Management interface application 165 deployed as described in the foregoing may facilitate performing a variety of tasks and processes in association with business management application 180 at least in part by providing suitable interface functionality via management interface 120.

It should be appreciated that, while application computer 160 and server 170 are illustrated as separate networked computers, management interface application 165 and business management application 180 may be deployed on the same computer and/or distributed over one or more shared computers, as there are no limitations in this respect. That is, the functionality described in connection with system 100 may be implemented in any manner and/or performed using one or multiple computers distributed in any manner via network 150.

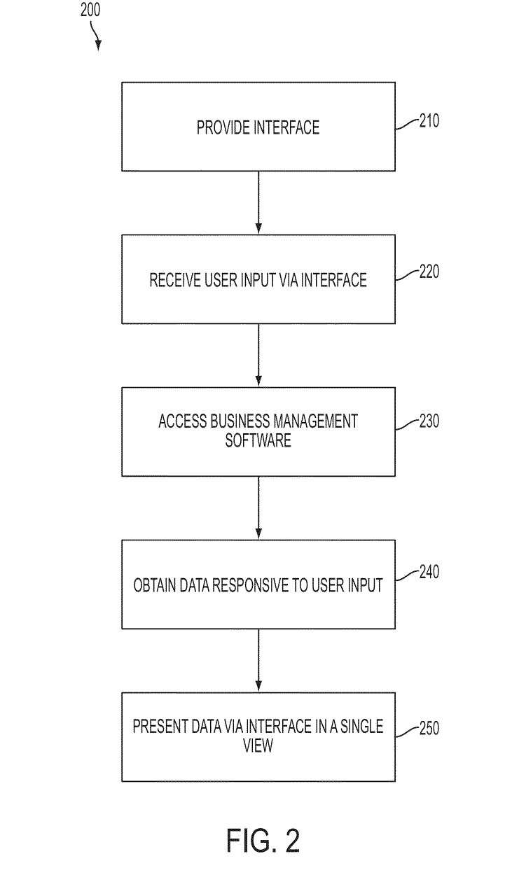

FIG. 2 illustrates a method of providing a management interface, in accordance with some embodiments. Method 200 may be performed to provide a management interface for any suitable business management application, such as a customer management application, by providing access to a business management software system (e.g., a third-party business management software system, such as SAP or Oracle) and by presenting information from the business management software system via the management interface. The management interface may be configured to present a convenient and efficient interface that allows a user of the management interface to perform tasks associated with the data managed by the business management application relatively quickly and easily, and in an intuitive manner, aspects of which are described in further detail below.

In act 210, a management interface is presented to a user. The management interface may be provided by a management interface application and presented to the user in a manner similar to that described in connection with system 100 in FIG. 1, or in any other suitable way. For example, a cloud-based application may provide management interface data that is rendered to a user via an internet browser executing on a client computer (e.g., a personal computer, user terminal, mobile device, etc.). The management interface may be designed to facilitate interaction with specific business management software (e.g., a business management application or application(s) capable of providing business management functionality), such as customer account management software (e.g., a billing and disbursements application to manage related transactions with a plurality of customers).

According to some embodiments, the management interface is presented to the user in response to the user navigating, via an internet browser, to an application server using an appropriate URL to launch a corresponding management interface application that is configured to communicate with the business management application. Alternatively, a management interface application may reside on the client computer and be rendered via an internet browser or via an interface produced by the management interface application executing on the client computer (e.g., a standalone network application, or other special purpose application), as the aspects are not limited to any particular implementation.

The management interface may be designed to provide interface functionality to the user that facilitates performing one or more tasks in connection with the data managed by the business management application. According to some embodiments, the management interface is designed to allow the user to access and manipulate customer data associated with one or more customer accounts managed by the business management application. In this respect, the management interface may present to the user options regarding tasks that may be performed in connection with customer accounts and/or provide access to customer data of interest so that one or more tasks may be performed. Illustrations of non-limiting presentations corresponding to exemplary tasks are discussed in further detail below, in accordance with some embodiments of a management interface.

In act 220, user input is received via the management interface. The user input may be of any form and may depend on the client device being utilized to render the management interface. For example, a user may interact with the management interface via keyboard or keypad, mouse, touch screen, speech or any other suitable input means. The user input may be a request for data, a command, a response to a question or query, or may itself be a question or query. For example, a user may request customer data for one or more customers whose accounts are managed by the business management application. The management interface may allow the user to search for or identify a customer in one or multiple ways such as allowing the user to specify one or any combination of customer name, account number, account type, etc., or specify any other criteria by which one or more customers that meet the specified criteria may be identified and corresponding customer data presented. In this manner, a user may obtain customer data associated with one or more customer accounts that the user would like to inspect or upon which the user may want to perform one or more tasks.

In act 230, business management software may be accessed in response to the received user input. For example, one or more queries may be provided to the corresponding business management application based at least in part upon the user input provided in act 220. According to some embodiments, user input received via the management interface is provided to a management interface application (which may be located on one or more application servers accessible via a network, may be located on the client computer, or may have components located both on the client computer and on one or more network accessible application servers). In response, the management interface application generates one or more queries to obtain data from the business management application. For example, if the user input identifies a customer, the management interface application may generate one or more queries to obtain customer data corresponding to the identified customer.

Conventionally (e.g., using conventional interface functionality provided by the business management application), in response to user input identifying a customer, the business management application might access a database storing customer data to locate the identified customer and provide demographic data on the customer (e.g., account number and contact information such as address and phone number) via an interface screen. If the user wanted to view account information, the user may have to provide further input to the interface and, in response, another access to the database is performed and an additional screen generated and populated with the requested data. If the user needs to review recent transactions, further requests from the user, accesses to the database and screen generation are required to do so. Each further request from the user may also require information obtained in one or more previous requests such that numerous steps must be completed by the user to accomplish even relatively simple tasks.

Some of the deficiencies in this conventional approach result from poor design based on a model driven by simply returning data requested by the user without any understanding of what task the user is trying to perform. As discussed above, the inventor has appreciated that a process oriented interface designed to take into account tasks that a user may want to perform may be better suited to facilitate the completion of those tasks efficiently and intuitively. According to some embodiments, in response to receiving user input to obtain data via a management interface (e.g., act 220), a management interface application may generate a set of queries or accesses designed to obtain all of the customer data that may be needed to complete one or more given tasks (e.g., act 230) such that this obtained customer data may be presented in a single consolidated view. In this respect, obtaining customer data in response to the received user input may utilize multiple accesses or exchanges with the business management software. However, the multiple accesses or exchanges are enacted in response to the same user input received in act 220, and the results of said accesses or exchanges are provided such that they may be presented in a single view.

In act 240, customer data is received from the business management software in response to the one or more queries generated to obtain customer data responsive to the user input received in act 220. In some embodiments, the business management software is coupled to, or includes, a database that stores customer data associated with a plurality of customer accounts and customer data from the database is obtained in response to the queries generated in act 230. For example, the user input received in act 220 may indicate a request for information on a particular customer, and data associated with that customer may be obtained in act 240 based on the user input. However, any data responsive to the user input may in general be obtained in act 240.

In act 250, the customer data obtained in act 240 is presented via the interface in a single consolidated view. For example, a management interface application may obtain the customer data from the business management application (or associated database) and generate management interface data describing a presentation of the data (e.g., the management interface data may be generated using one or more web-based protocols, languages, mark-ups, etc.). The management interface data may then be presented to the user in a single view via the management interface operating on the client computer.

As discussed above, the term “view” refers to a presentation of a collection of data (e.g., customer data) obtained from a business management application and accompanying interface elements that, once the collection of data is obtained via one or more queries, accesses and/or exchanges with the business management software, no further accesses to the business management software is needed to obtain further data for the corresponding view. It should be appreciated that a view may include one or more view elements (windows, tabs, menus, buttons, text, images, video, audio, links, frames, tables, forms and text boxes) and/or a portion of the collection of data associated with the view that are hidden though nonetheless present in the view, and that may be made visible via interaction with the view (e.g., via interacting with the visible view elements).

For example, customer data may be presented in a single view that includes a first set of view elements and a visible portion of the customer data that are displayed and a second set of view elements and a hidden portion of the customer data that are hidden. The user may interact with the displayed view elements and/or displayed customer data forming the view resulting in displaying further view elements and/or customer data and changing the manner in which the view is presented. However, because only a single view is being presented, further access to the business management application is not needed while the user performs actions within that view.

As a result, a significant portion, most or all of the business and/or customer data the user may need to perform a task may be made readily available in a single view to eliminate the numerous requests and accesses that would be required using conventional approaches. As discussed in further detail below, such a view may be presented in a manner that is intuitive with respect to the task(s) the user wants to achieve. As a result, a management interface may provide functionality that allows a user to complete tasks in a relatively quick, efficient and intuitive manner.

Additionally, the user may provide input, via the single view (alone or in combination with further views), that modifies customer data managed by the business management application, initiates one or more transactions associated with the customer data and/or otherwise performs one or more functions associated with the customer data. Such user input may be received via the management interface and action taken in response by a management interface application configured to exchange data with the business management application to assist in performing the one or more desired tasks.

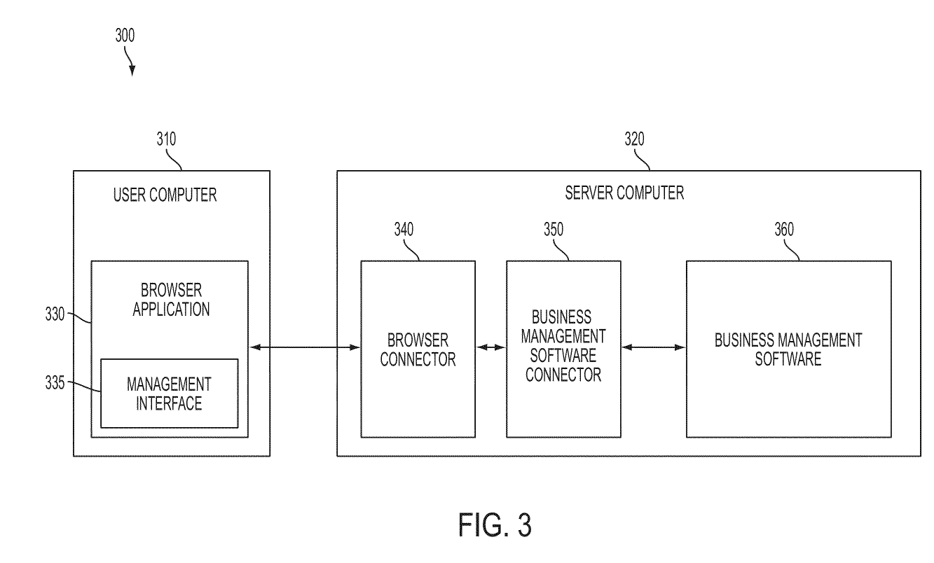

FIG. 3 depicts a block diagram of system 300 suitable for practicing management interface techniques according to some embodiments. For example, the method described in connection with FIG. 2 may be implemented and performed on system 300. In system 300, user computer 310, via browser application 330, accesses and renders a management interface 335 provided by server computer 320. Server computer 320 includes and executes business management software 360, business management software connector 350 and browser connector 340, which can exchange information necessary to provide management interface 335 to browser application 330 to be rendered to the user.

A user may access business management software 360 functionality using browser application 330, via browser connector 340 and business management software connector 350 by interacting with management interface 335. Browser application 330 may include any application capable of presenting management interface 335. For example browser application 330 may be a web browser, such as, but not limited to, Internet Explorer, Firefox, Opera, Chrome, Safari, etc. Alternatively, browser application 330 may be a client application (e.g., installed on user computer 310) specially programmed to render a management interface based on information received from server 320.

User input may be captured by browser application 330 using any suitable technique and/or any suitable device(s). For example, user input may be received using a keyboard, mouse, trackpad, touch screen, voice input, or combinations thereof. Browser application 330 may provide user input to server 320 via browser connector 340. Information based on the user input may be provided to browser connector 340 using any suitable mechanism, including but not limited to client-side scripting languages such as JavaScript, Silverlight, Flash, Java, Actionscript, and/or an combinations thereof. According to some embodiments, communication between user computer 310 and server computer 320 is achieved in significant part using internet or web-based technologies (e.g., internet/web suitable languages, protocols, standards, etc.), though there are no limitations on the implementation in this respect.

Browser connector 340 may process the information received based on the user input and in response generate one or more queries to obtain data associated with the business management application (e.g., business and/or customer data). The desired data to be obtained in response to the received user input may include data to be provided by business management software 360, though may alternatively or additionally include data cached by browser connector 340 (which may itself have previously been obtained from the business management software), and/or may include data that originated with the browser connector or is/was obtained elsewhere (e.g., from another location on the network). In this respect, browser connector 340 may be configured to communicate with business management software 360 according to the protocol/format utilized by business management software 360 (e.g., browser connector 340 is adapted to generate queries and/or exchange data in a manner compatible with business management software connector) to assist in carrying out the intent of the user.

Browser connector 340 performs, at least in part, the function of obtaining data (primarily, but not limited to, business and/or customer data from business management software 360) responsive to user input so as to provide management interface data to browser 330 for presentation to the user as management interface 335, examples of which are described in further detail below. According to some embodiments, browser connector 340 is designed to process user input and formulate a set of queries such that all of the data needed for a user to complete one or more tasks can be consolidated in a single view to be presented to the user via management interface 335. In this respect, browser connector 340 may be configured to obtain and organize data in a process-oriented manner such that the data and interface elements presented to the user facilitate the user performing tasks in a generally efficient manner.

Browser connector 340 may provide management interface data to browser application 330 for rendering as management interface 335 using any suitable format, protocol or standard for communicating content. As non-limiting examples, browser connector 340 may utilize HyperText Markup Language (HTML), which may include XHTML, HTML5, XML, CSS, JavaScript, or any combination thereof. For example, views to be presented to the user via management interface 335 may be represented as respective HTML web pages. In this manner, browser connector 340 operates much like a web server by providing management interface data as web pages to browser application 330 for presentation as management interface 335.

Browser connector 340 may include any suitable software able to generate content in a desired format for presentation as management interface 335 presented via browser application 330. For example, browser connector 340 may include server-side scripting software such as, but not limited to, PHP, ASP, ASP.NET (e.g., including C, C++, C#, VB, etc.), Python, Java, Server-side JavaScript, ColdFusion, CGI, Lua, and combinations thereof. However, other suitable technique(s) may be utilized alternatively or in addition to so as to provide a user with a useful management interface. It should be appreciated from the foregoing that data presented via browser application 330 may include data associated with a business and/or customer (e.g., provided by business management software 360), as well as data relating to formatting, organization and/or aesthetic aspects of the presentation of management interface 335, as the content provided by browser connector 340 is not limited in this respect.

In some embodiments, browser connector 340 is configured to query business management software 360 in order to cache data that may be subsequently provided to browser application 330 for presentation via management interface 335. By caching data from business management software 360 that is expected to be frequently requested and/or that is expected to be frequently utilized by one or more views, browser application 330 may be capable of more efficiently providing this data when it is needed by avoiding the necessity of further exchanges with business management software 360 to retrieve the data. Cached data may include any desired information including, but not limited to, customer data (e.g., demographic data, account information, documents, policies, contracts, etc.), fields, lists of categories, or any other information that may benefit from being cached so that presentation of the information may be expedited, some examples of which are discussed in further detail below.

Business management software connector 350 provides an interface to business management software 360 to allow data exchange with browser connector 340. Typically, business management applications provide one or more connectors that expose particular functionality of the business management application to other applications. For example, business management software connector 350 may be an application programming interface (API) that allows applications to access business management functionality via function calls to the API. However, business management software connector 350 may provide access to business management software 360 in any suitable way, as connecting to and exchanging data with a business management application is not limited to any particular technique or implementation.

According to some embodiments, business management software connector 350 provides security for access to business management software 360, for example, by allowing browser connector 340 to access the exposed functionality while respecting the security model and access privileges of the business management software. In some embodiments, browser connector 340 may provide an interface element via browser application 330 for presentation to the user via the management interface 335 to allow a user to input security information (e.g., username and password), which security information may then be provided to business management software connector 350 to authenticate the user against the same access privileges utilized by business management software 360. In this manner, a management interface may be deployed without needing to implement a separate security scheme and/or requiring the management interface functionality to provide and/or maintain its own security model. In addition, the user need only maintain a single username/password combination to utilize the management information, according to some embodiments.

Typically, data managed by business management software 360 is stored in one or more databases included in and/or coupled the business management software. For example, business and/or customer data may be stored in one or more databases incorporated within or accessible by business management software 360. The database may include any suitable combination of hardware and/or software for storing data, and may for example include a relational database, object-oriented database, etc. Alternatively or additionally, a database may include one or more database management systems (DBMSs) including, but not limited to, Oracle, Sybase, IBM DB2, Informix, Neteeza, MySQL, Microsoft Access, dBASE, and/or any combinations thereof.

The system illustrated in FIG. 3 is capable of providing a management interface that allows a user to interact with a business management application in a generally user-friendly, intuitive manner to facilitate performing one or more manual tasks associated with data managed by the business management software. In particular, the management interface 335 may be configured to facilitate data exchange between the user and the business management application 360, via browser connector 340, to request data from, apply data to and perform functions associated with the business management application. According to some embodiments, the management interface functionality may be implemented with little or no modification to the underlying business management software, such that a management interface can be deployed with little disruption to the business or organization seeking to deploy the manage interface. Additionally, some embodiments exploit the existing security model such that users enjoy the same access privileges without needing to remember or otherwise manage different security information (e.g., without needing a separate username and password).

It should be appreciated that user computer 310 may be any type or combination of suitable device(s) such as a personal computer, user terminal, mobile device, etc. and may be coupled to any number and type of interface devices designed to allow a user to interact with user computer 310. Server computer 320 may comprise any number of devices of any type, and may employ any number of processors located at a single location or distributed over multiple locations either locally or remotely over a network. For example, server computer 320 may include data storage located in multiple data centers and accessed by software executing on any number of processors capable of accessing the data centers. In some embodiments, server computer 320 is configured as a web server. For example, server computer may execute any suitable web server software, including but not limited to Apache, Microsoft Internet Information Services (IIS), Nginx, and Google Web Server (GWS), etc. As such, browser connector 340, business management software connector 350 and business management software 360 may be implemented on a same server (or servers) or distributed over multiple servers in any suitable manner, as the manner in which the functionality is implemented is not limited to any particular network configuration or distribution.

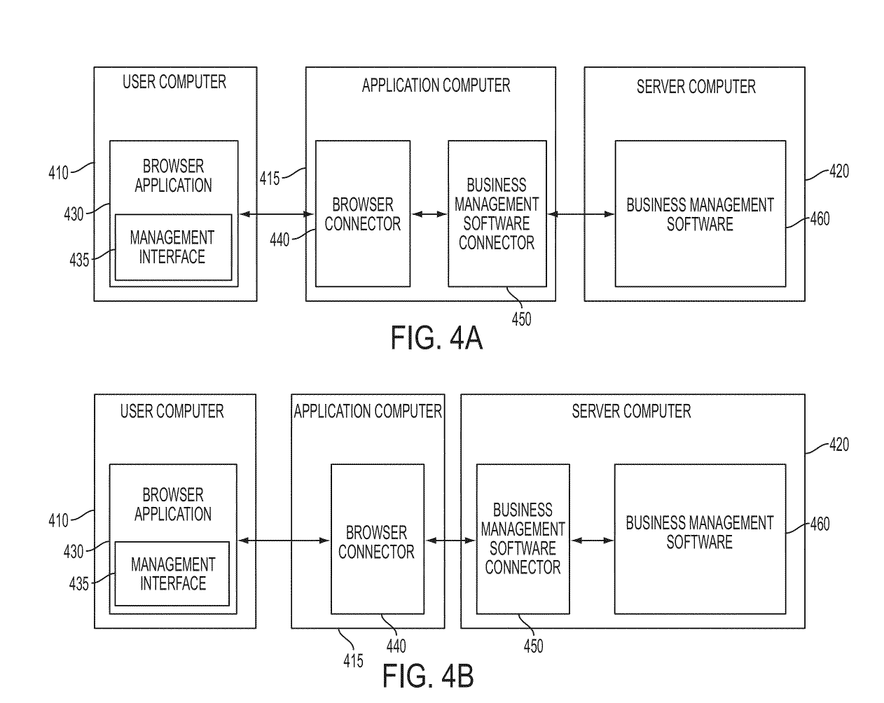

For example, FIGS. 4A and 4B illustrate two additional exemplary configurations of the system described in connection with FIG. 3. In particular, the systems illustrated in FIGS. 4A and 4B utilize a user computer 410 to render a management interface 435, via browser application 430, provided by a browser connector 440. The browser connector 440 communicates with business management software connector 450 to access data managed by and functionality provided by business management software 460. These elements operate in a manner consistent with the above discussion with respect to browser application 330, browser connector 340, business management software connector 350 and business management software 360, respectively. However, the system illustrated in FIG. 4A implements browser connector 440 and business management software connector 450 on application computer 415 and the system illustrated in FIG. 4B implements the browser connector 440 on application computer 415 and business management software connector 450 on server 420 along with the business management software 460.

The systems illustrated in FIGS. 4A and 4B may have an advantage over system 300 in that computing resources (e.g., processing, memory, etc.) may be made separate for the browser connector and the business management software. Business management software may utilize a large amount of system resources (e.g., due in part to large data volumes), so having computing resources that can be more significantly devoted and/or dedicated to the business management software may have increased efficiency from the standpoint of delivering business management software functionality (e.g., automating business processes for the business or organization utilizing the software).

On the other hand, system 300 may have an advantage over the systems illustrated in FIGS. 4A and 4B in that data exchange between the browser connector and the business management software is performed via a network, which may incur additional latency and delays as a result of this network communication. The systems illustrated in FIGS. 4A and 4B may be more attractive for some implementations where it is desirable to separate the management of the components of the system. Thus, the systems illustrated in FIG. 3, FIG. 4A and FIG. 4B represent alternative embodiments that may be employed in accordance with the needs, resources and circumstances of a given implementation. As discussed above, any other suitable arrangement of the components of the system may be utilized as well, as the techniques described herein may be implemented according to any desired configuration and distribution.

It should be appreciated from the foregoing that the systems described in connection with FIG. 3, FIG. 4A and FIG. 4B may be designed to present a management interface to a user that allows generally intuitive access to the business and/or customer data associated with a business management application, as well as access to functionality of the business management application. As such, the management interface may be adapted to allow a user to request data from a business management application, apply data to a business management application, initiate one or more transactions associated with customer data and/or perform one or more functions associated with the customer data via the data exchange techniques involving the exemplary browsers (e.g., browser applications 330 and 430) and the exemplary connectors (e.g., browser connector 340/440 and business management software connector 350/450) discussed above.

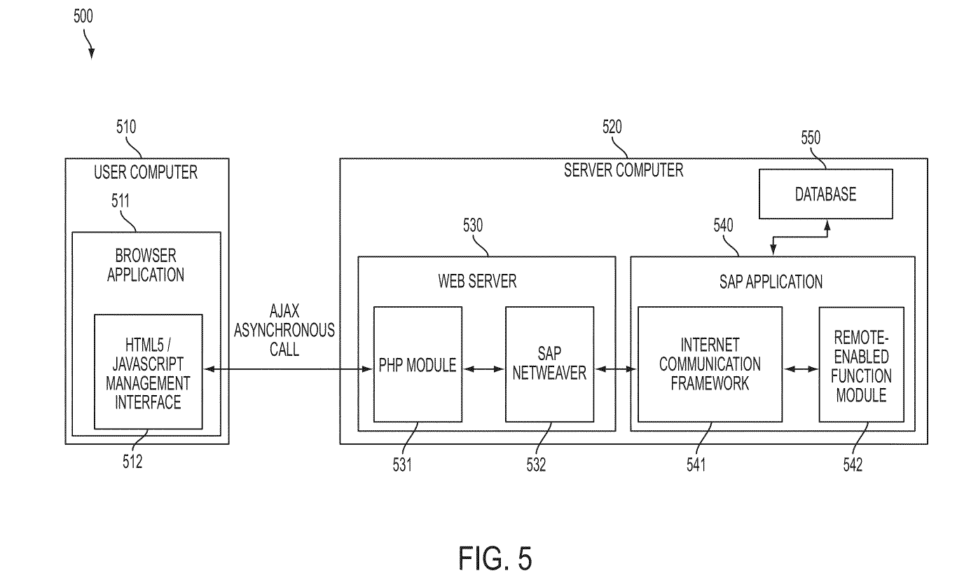

FIG. 5 illustrates a system that includes a management interface provided to facilitate interaction with a particular business management application, and in particular SAP, in accordance with some embodiments. Specifically, FIG. 5 illustrates a particular implementation of management interface functionality described herein (e.g., as described in connection with FIGS. 1-4) in the context of an SAP business management application. In system 500, user computer 510 accesses and presents a management interface 512 provided by server computer 520 via browser application 511. Server computer 520 (which may include a single server, or multiple servers accessible at a single or multiple locations on a network) includes SAP application 540, an exemplary business management application that may, for example, provide high volume billing and disbursement functionality. Server computer 520 also includes database 550, which may be part of, and/or coupled to, SAP application 540. For example, business and/or customer data relating to SAP application 540 may be stored in database 550. In some embodiments, security authentication data is also stored in database 550.

A management interface 512 is provided to the user computer 510 from web server 530, which communicates with SAP application 540 via the SAP Internet Communication Framework (IFC) 541. Data may be provided to/from SAP from/to the web server via SAP Netweaver 532. As used herein, the term “SAP Netweaver” refers to aspects of the product known as “SAP Netweaver RFC SDK.” As discussed above, SAP application 540 is coupled to database 550, which stores business and/or customer data (e.g., data relating to billing and disbursement in connection with a plurality of customer accounts). Accordingly, a user may access and view business and/or customer data stored by the SAP application by viewing information presented in the browser application and providing user input in response.

Browser application 511 may utilize HTML5 and JavaScript to present a management interface that facilitates interaction with SAP application 540. For example, business and/or customer data retrieved from SAP application 540 may be used to generate an HTML5 web page (e.g., by web server 530), which structures and presents the data to be presented in management interface 512 via browser application 511. JavaScript may provide techniques to dynamically generate and modify content in the browser without receiving additional data from web server 530, and may be integrated into the HTML5 web page to provide additional functionality to a user viewing the web page. For example, JavaScript may allow a user to show and hide aspects of a web page (e.g., make visible, hide and/or otherwise present or organize data in a view), may allow for dynamic sorting of data (e.g., a table) and/or may provide other dynamic web page features, each without requiring additional data to be provided from web server 530. Advantages of utilizing JavaScript in the example of FIG. 5 may include a functionally rich user experience wherein the user may manipulate presented business and/or customer data without requiring further accesses of web server 530 and/or SAP application 540.

User input received via the browser application may be provided to web server 530. For example, JavaScript executed by browser application 511 (e.g., one or more JavaScript functions) may receive user input and provide information based on the user input to web server 530 via an AJAX (Asynchronous JavaScript and XML) asynchronous call. Information based on received user input provided by browser application 511 may include, but is not limited to, business and/or customer data, parameters (e.g., JavaScript parameters), data provided in a web form, parameters in a URL (Uniform Resource Located) of a web page, the type of browser being used, and combinations thereof. Since, in the example of FIG. 5, information based on user input is provided to the web server asynchronously, a user may continue to use the management interface presented by browser application 511 in its current state while the web server processes the information received and assembles an appropriate response (e.g., while the web server evaluates the information received in response to the user input and performs any appropriate actions such as querying SAP application 540 and/or generating management interface data to be rendered by browser application 511 as management interface 512).

Web server 530 may include any suitable server capabilities adapted for delivering web content to user computer 510, including but not limited to, one or more servers executing web server software including, but not limited to, Apache, Microsoft Internet Information Services (IIS), Nginx, and Google Web Server (GWS), etc. In the embodiment illustrated in FIG. 5, web server 530 also includes PHP module 531, which utilizes the PHP scripting language to communicate with SAP Netweaver 532 and browser application 511. For example, information based on user input received by browser application 511 may be provided to PHP module 531 and an HTML5 page may be produced (i.e., generated, selected and/or modified) by PHP module 531 and returned to browser application 511 for presentation via management interface 512. Alternatively, or additionally, PHP module 531 may generate one or more queries, based at least in part on received user input, and provide the one or more queries to SAP Netweaver 532. For example, one or more queries may be generated to request particular data from SAP Application 540 (e.g., customer data to be presented to the user via the management interface in a single consolidated view).

In some embodiments, web server 530 receives data from SAP application 540 and caches the data such that it may be subsequently provided to the browser application 511. For example, by caching data from SAP application 540 expected to be requested frequently and/or to be requested at some point, subsequent requests for that data may be fulfilled more efficiently by retrieving the data from web server 530 rather than from SAP application 540. For example, cached data may comprise data received from SAP application 540 that is provided via the management interface based on user input (e.g., when a user actuates a particular interface element). As a result, the responsiveness of the management interface may be improved by avoiding repeat accesses to SAP application 540 in situations where the appropriate data has been cached.

PHP module 531 may access data managed by SAP application 540 by providing one or more queries to SAP Netweaver 532 (e.g., one or more queries responsive to received user input, or to obtain information to present in one or more initial views to the user via the management interface, etc.). SAP Netweaver 532 is a connector provided by SAP that exposes remote-enabled functions to other applications (such as web server 530). In general, SAP Netweaver utilizes the same security platform as SAP application 540, so a user may utilize the same credentials (e.g., username, password) when connecting to SAP application 540 via SAP Netweaver 532 that they would use when performing actions that connect to SAP application 540 conventionally, e.g., via native interface functionality.

In the example of FIG. 5, SAP Netweaver 532 may receive a query provided by PHP module 531 (which may be provided asynchronously), and provides the query to SAP application 540. SAP application 540 includes (or is coupled to) Internet Communication Framework 541, which may be a component of SAP application 540 provided to allow communication by remote applications, and as such, may be utilized by web server 530 to exchange data with SAP application 540 (e.g., to receive data from or provide data to SAP application 540). For example, Internet Communication Framework 541 may allow web server 530 to communicate with SAP application 540 using a standard Internet protocol, such as HTTP, HTTPS, etc.

SAP application 540 may also include Remote-Enabled Function Module 542 (also referred to as a Remote Function Call (RFC) Interface), which may be provided to allow remote function calls from, for example, SAP Netweaver 532. Queries for data from, data to be applied to and/or functions provided by SAP application 540, received by SAP Netweaver 532, may be communicated (synchronously or asynchronously) to Remote-Enabled Function Module 542 across the Internet Communication Framework 541. According to some embodiments, communications provided to Remote-Enabled Function Module 542 are written, at least in part, in the ABAP (Advanced Business Application Programming) language provided by SAP. For example, PHP module 531 may be configured to generate communications using the ABAP language compatible with SAP application 540. In this manner, communication is made possible between SAP application 540 and the management interface functionality to facilitate providing management interface 512 to a user via browser application 511.

When a communication to SAP application 540 includes one or more queries or requests for data (e.g., customer data), data responsive to the one or more queries/requests may be produced by SAP application 540 (e.g., by accessing a database to obtain the appropriate information) and Remote-Enabled Function Module 542 may be communicate the data to PHP module 531 via the Internet Communication Framework 541 and SAP Netweaver 532. PHP module 531 may process the data to select, modify and/or otherwise produce an HTML5 web page to present obtained data to the user. For example, PHP module 531 may generate one or more queries to SAP application 540, as described above, either in response to user input or independent of user input, to obtain business and/or customer data associated with one or more customer accounts managed by SAP application 540. Business and/or customer data obtained in response to the one or more queries may be incorporated into an HTML page for presentation to the user via the management interface 512 rendered by browser application 511.

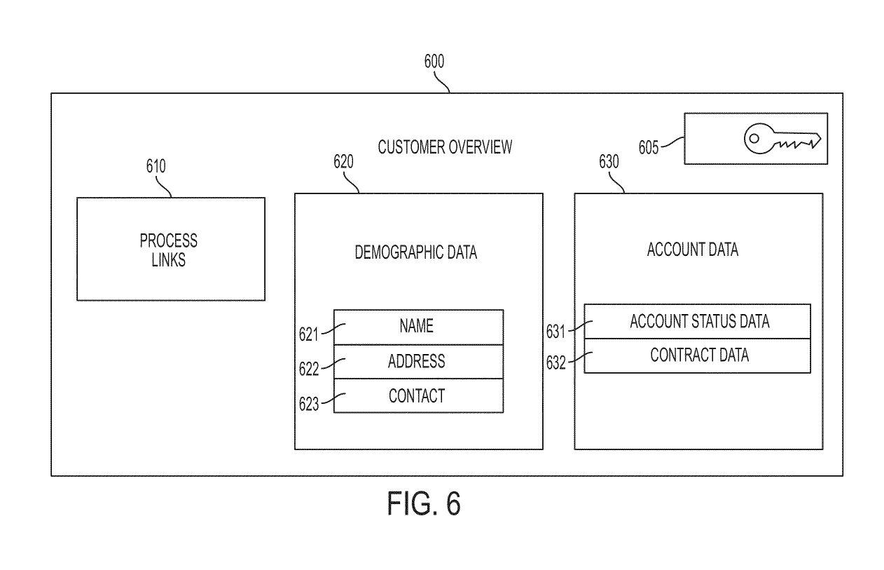

Accordingly, a management interface that facilitates user interaction with SAP application 540 may be implemented, at least in part, by producing (e.g., selecting, generating, modifying and/or updating) HTML web pages for presentation to a user via browser application 511. According to some embodiments, HTML web pages (e.g., using HTML 5 and/or JavaScript technologies) may be produced such that interface functionality (e.g., business and/or customer data and accompany interface elements) needed to perform one or more tasks may be presented to the user in a single consolidated view. One exemplary consolidated view in accordance with some embodiments is described below in connection with FIG. 6. It should be appreciated that while providing particular functionality to facilitate performing one or more tasks in a single view may facilitate more efficient and intuitive interaction with a business management application (e.g., SAP application 540), not all views presented to the user need to do so, as a management interface may comprise any number of views of any type and aspects of presenting interface functionality is not limited in this respect.

As discussed above, some embodiments implementing management interface functionality utilize the same security credentials as the underlying business management application (e.g., SAP application 540 in FIG. 5). Security authentication data may be obtained from the user by web server 530 by, for example, providing an authentication or login page to be presented to the user via browser application 511. Security authentication data received from the user via the authentication page (or some portion thereof) may be used to “login” the user and may be included in communications directed to SAP application 540. In this manner, a manage interface may take advantage of the security mechanisms of the business management application so that a user can use the same credentials (e.g., username and password) when accessing the business management application via the management interface and enjoy the same access privileges associated with the credentials.

As discussed above, the inventors have appreciated that providing customer data and accompanying interface elements sufficient to allow a user to complete one or more tasks in a single view may facilitate more convenient, efficient and/or intuitive performance of the one or more tasks. FIG. 6 illustrates an exemplary view 600 of a management interface, according to some embodiments. View 600 may be provided responsive to a user requesting customer data associated with a customer account managed by a business management application (e.g., a user may have selected or input information identifying the customer of interest via the management interface, for example, via a different view presented to the user). As discussed above, view 600 is presented via a management interface, such as management interface 120 shown in FIG. 1, and/or the management interfaces 335, 435 and/or 512 presented by browser applications 330, 4300 and/or 511 in FIGS. 3, 4, and 5, respectively.

View 600 may be useful, for example, in presenting an overview of account data for a particular customer so that the user can inspect the status of the customer's account(s), make manual changes to the customer's account(s) and/or perform one or more other tasks associated with the customer data, some examples of which are discussed in further detail below. View 600 represents a single exemplary view of data corresponding to or managed by the associated business management application and, as such, comprises a collection of data and the accompanying interface elements (also referred to herein as view elements) that can be presented to the user without further accesses to the business management application. View 600 may include, in addition to the view elements and business and/or customer data visible in FIG. 6, one or more hidden view elements presenting customer data that is not visible in the presentation shown in FIG. 6, but which may be made visible via user interaction with the management interface.

Visible in view 600 as shown in the embodiment illustrated in FIG. 6 is view element 620 for presenting demographic data associated with the specified customer. The demographic data may include any one or combination of customer name, address, and contact information such as telephone number, facsimile number, email address, etc. For example, view element 620 may include view elements 621, 622 and 623, which provide name, address and contact data, respectively. Each of view elements 621, 622 and 623 may be presented in any suitable way. For example, customer demographic data may be shown as text, and/or as text within one or more text boxes or editable fields so that the user can edit one or more aspects of the customer data.

Name data presented via view element 621 may include the name of the customer (e.g., the business or individual associated with the customer account). Address data presented via view element 622 may, for example, include one or more home addresses and/or business addresses of the customer. Contact data presented via view element 623 may include, for example, one or more email addresses, phone numbers, and/or fax numbers. Moreover, view element 620 may also include further information associated with the customer, such as a customer ID number used by the business management application to uniquely identify the customer, and/or values representing, for example, types and/or groups to which the user belongs.

Also visible in view 600 as shown in the embodiment illustrated in FIG. 6 is view element 630 for presenting account data. Account data may include any one or combination of account or policy number(s), account status data, account summary information, contract or policy information, transaction history, etc. Account data presented via view element 630 may include any account data associated with one or more accounts that are, in some way, associated with the customer. For example, the customer may be the primary holder of one or more accounts, and data associated with those accounts may be presented via view element 630. Account status data presented via view element 631 may include for each account, for example, an account balance, a number of open items, a number of past due items, a number of total items, and/or due dates of account entries. Contract data presented via view element 632 may include details of one or more contracts or policies with which the customer is associated. While there is no requirements or limitations with respect to the combination of customer data presented in view 600 (e.g., customer demographic data, customer account data, etc.), the customer data associated with view 600 is generally sufficient for a user to perform one or more tasks associated with the customer, as discussed in further detail below.

Also visible in view 600 as shown in the embodiment illustrated in FIG. 6 is view element 610 for presenting process links associated with tasks that a user may frequently engage in with respect to the corresponding business management application, some of which are discussed in further detail below. The process links may allow for easy navigation to interface functionality that facilitates the performance of a desired number of task or processes that are commonly performed by a user when interacting with a business management application. The interface functionality associated with the process links may be part of view 600, may correspond to different views, or a combination of both, as providing process links is not limited in this respect. It should be appreciated that providing process links with view 600 is not a requirement, but may be utilized to present a more convenient and intuitive management interface, as discussed in further detail below.

The type and number of process links (if any) presented on a view may depend on the type of business management application to which the management interface is providing user interaction. For example, for a billing and disbursement application, examples of process links may include any one or combination of a link associated with a process for entering a payment for a customer, a link associated with a process for generating reports associated with the customer, a link for manually manipulating customer data, a link for initiating one or more transactions or correcting one or more transactions, a link for viewing documents, etc., as a few non-limiting examples. Process links may be presented in any suitable way, such as via a hyperlink to view elements of the current view or to a new view that facilitates performance of the process, as the aspects are not limited in this respect.

View 600 may also include authorization update control 605, which may include an indication of the user's access privileges (e.g., an indication of the number of objects the user has access to) and an interface element that a user may actuate (e.g., click on) to update the user's access privileges. Conventional management interfaces may require a user to log out then log back into the system to ensure that the access privileges are up-to-date. Accordingly, if accesses privileges change for a user and/or new customer data is added (e.g., a new customer added for which the user is assigned access privileges), such changes may not be captured in conventional interfaces without inconvenient logging out and logging in procedures.

Authorization update control 605 allows a user to quickly and easily update the access privileges to ensure that the user knows when the access privileges have changed (e.g., via the indication of the access privileges and/or number of data objects to which the user has access) and to ensure that interaction with the business management application is conducted using the most up-to-date access privileges. According to some embodiments, when authorization update control 605 is actuated to update the access privileges, the management interface may also update the current view being presented to include appropriate customer data corresponding to the change in access privileges (e.g., to respond to a new customer being added, a new policy or contract being added to an existing customer, etc.).

It should be appreciated that FIG. 6 is a conceptual drawing of an exemplary view, and that in practice view 600 may be organized and/or presented differently than shown in FIG. 6. For example, any of the view elements described may be placed at any location within view 600, and may be formatted in any suitable way (e.g., using any suitable size, font, colors, images, buttons, etc.). Furthermore, any of the data presented via view 600 may include one or more links to elements of the same view or additional views displaying further data from the business management application with which view 600 is associated. For example, contract data presented via view element 632 may include a link associated with a particular contract that, when actuated by a user, results in the presentation of a view relating to the contract (e.g., displaying the contract document). However, in general any data presented in the view may include links as appropriate to provide a convenient way for a user to access and/or manipulate data provided by the business management application.

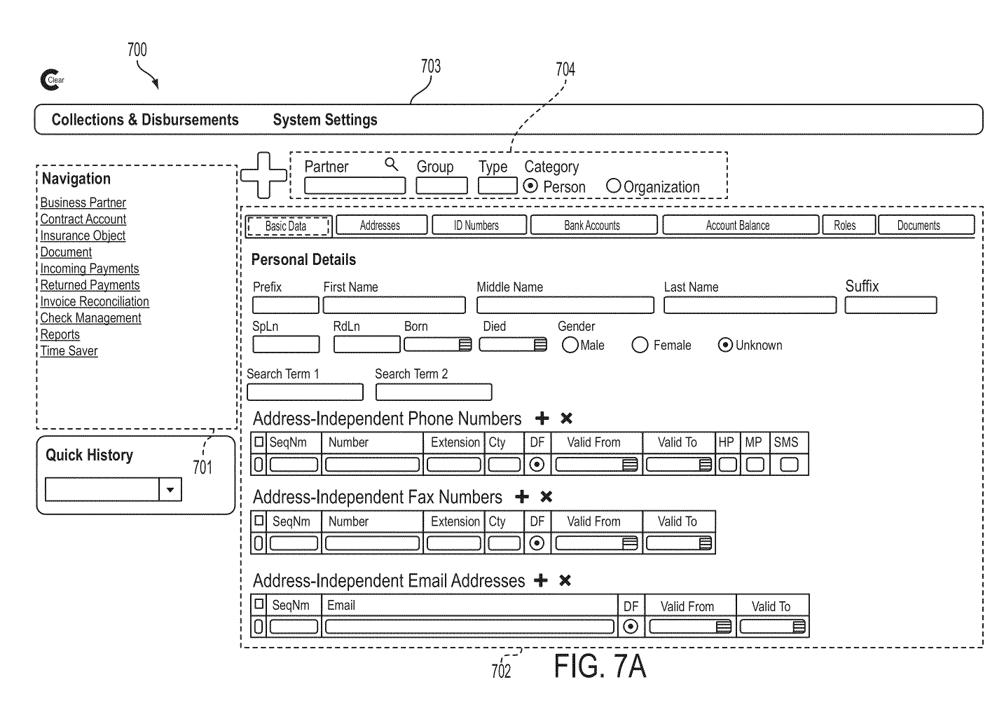

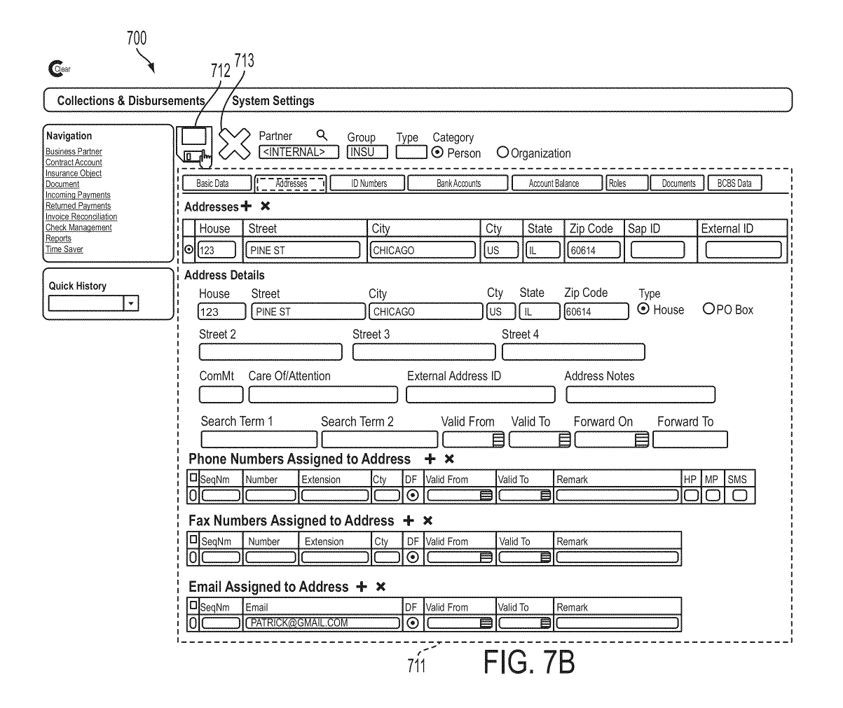

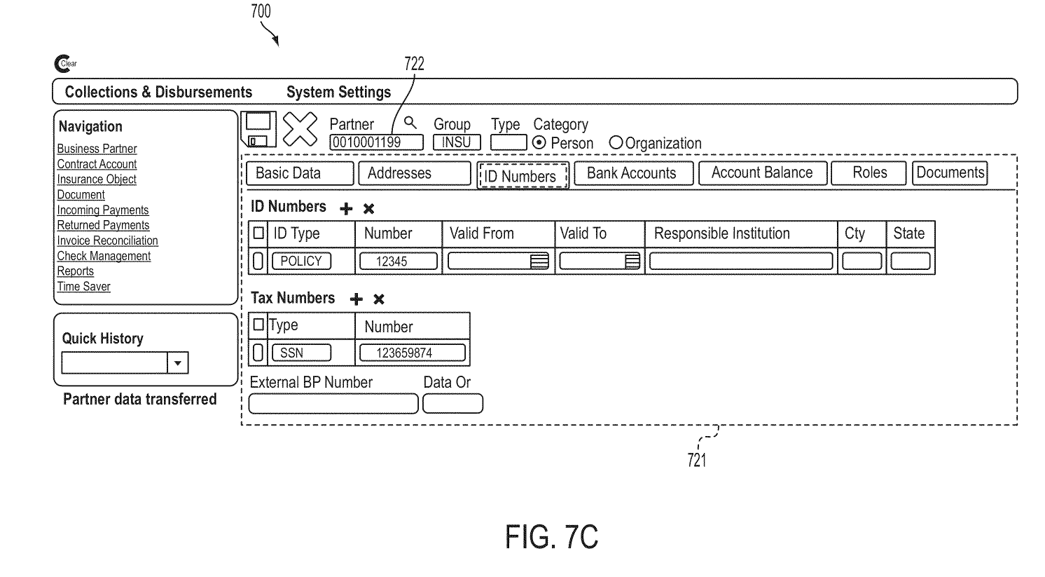

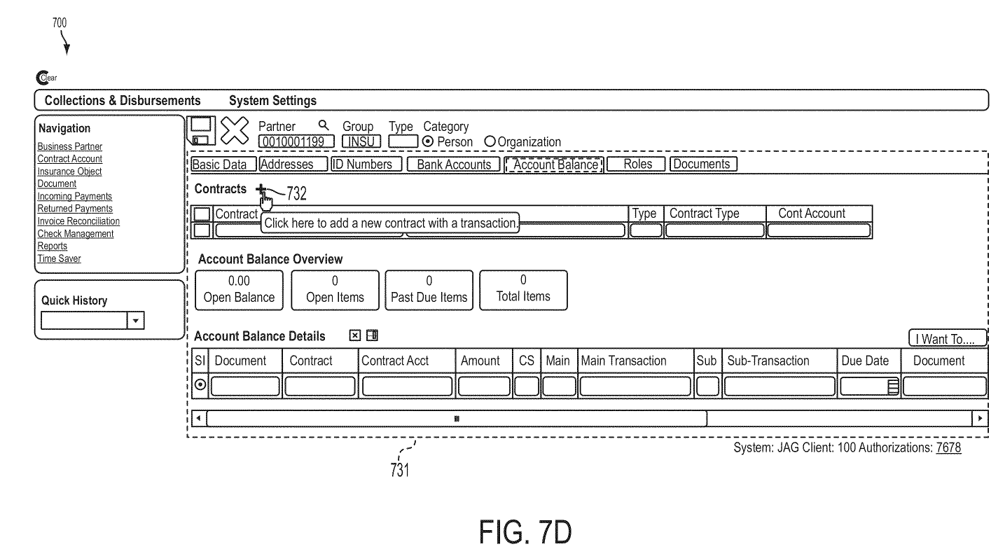

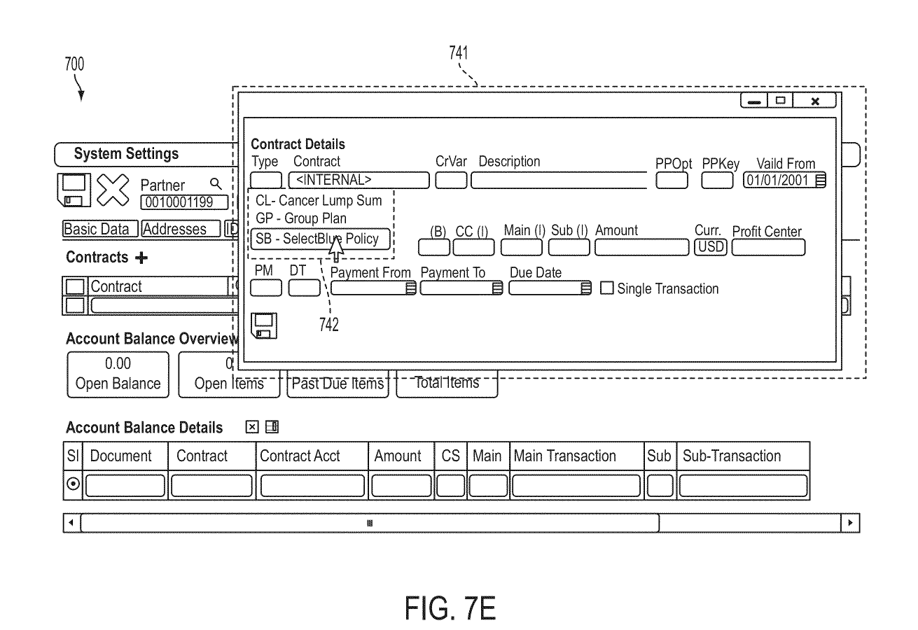

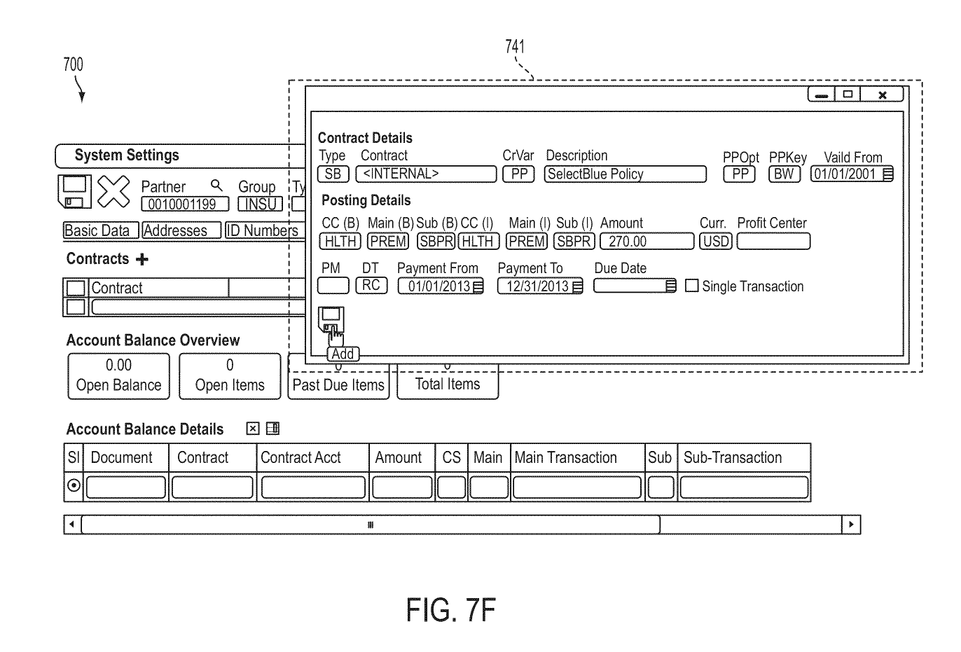

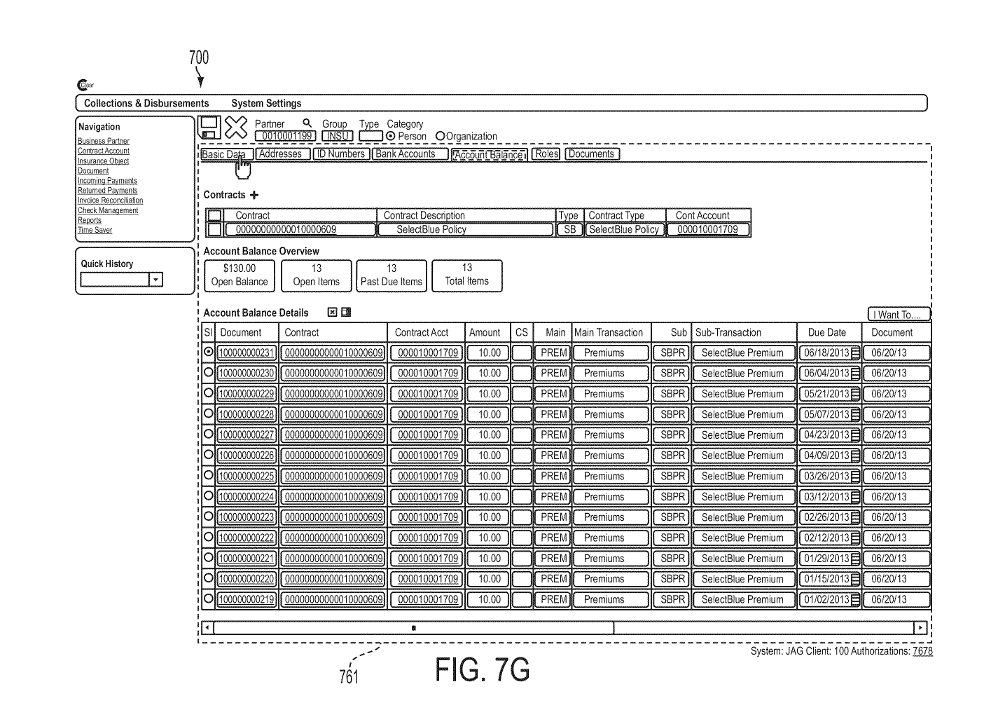

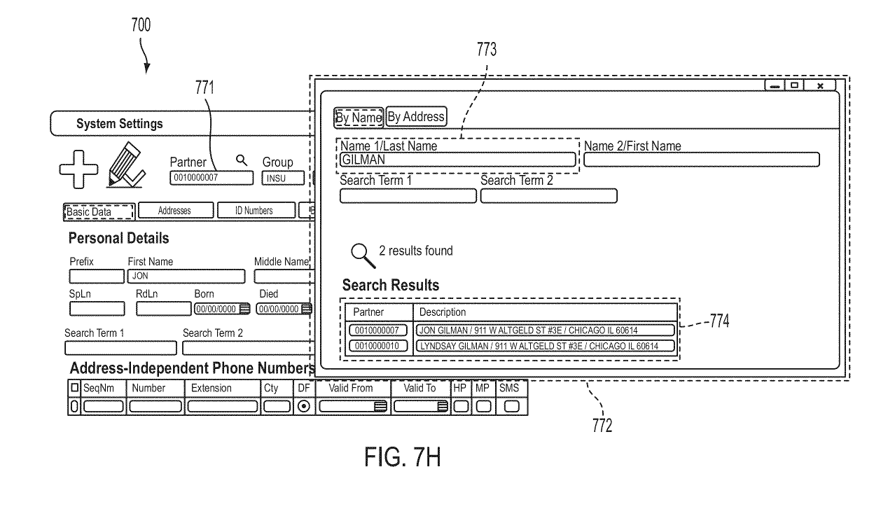

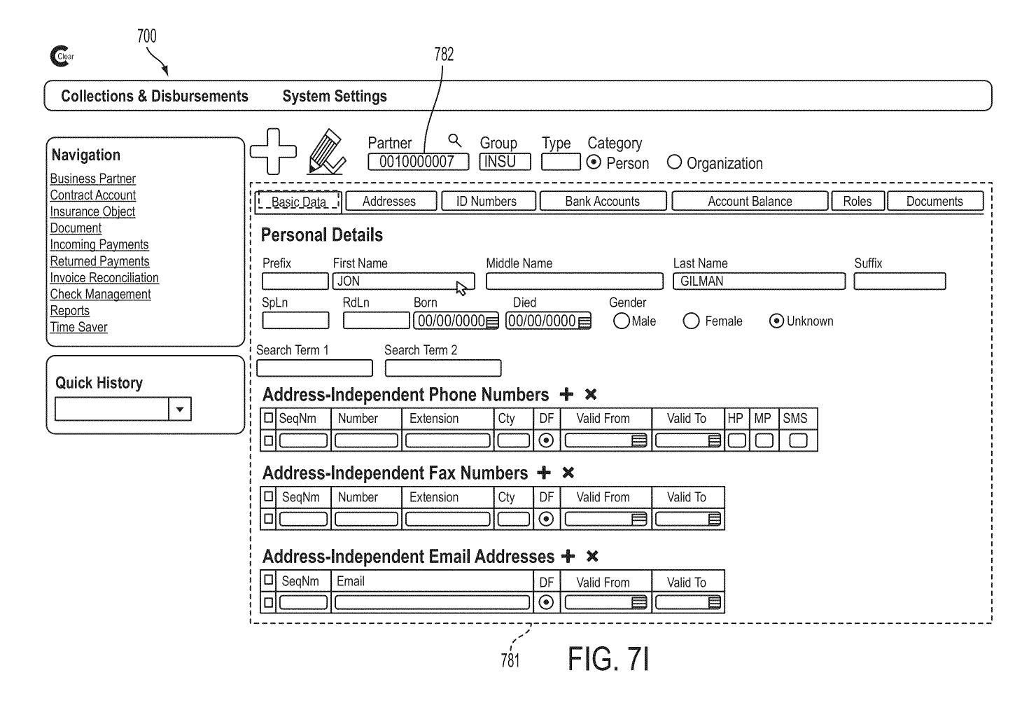

FIGS. 7A-G show a series of screen shots of an exemplary management interface, according to some embodiments, demonstrating an exemplary process of creating, viewing and manipulating customer data for an exemplary business management application, which in the example of FIGS. 7A-G may comprise a collections and disbursements management application. In the description of FIGS. 7A-G provided below, it should be appreciated that not every view element in the management interface depicted is discussed, and that the below description is provided merely to illustrate some aspects of the exemplary management interface depicted in the figures and discussed herein.

FIG. 7A depicts an exemplary view 700 that includes navigation view element 701 (similar in many respects to the process links described above in connection with view 600), business partner data view element 702, new business partner view element 703 and search view element 704. Navigation view element 701 includes a set of links corresponding to tasks/processes that the user may perform by selecting the corresponding link. The set of links presented may correspond to common tasks that a user may want to perform, and often represent tasks that are performed regularly (and often repeatedly on a frequent basis).

In the examples shown in FIGS. 7A-G, the user has selected the “Business Partner” link to present the corresponding business partner view. Among other things, the business partner view provides data associated with a particular business partner, allows a user to edit data associated with a business partner, allows a user to create a new business partner, etc. The term “Business Partner” as used herein is synonymous with a customer. The business partner view includes a number of tabs (“Basic Data,” “Addresses,” “ID Numbers,” “Bank Accounts,” “Account Balance,” “Roles” and “Documents”) that relate to various aspects of business partner data, and are accessible by selecting the appropriate tab displayed by business partner data view element 702 as part of view 700. In the example of FIG. 7A, the “Basic Data” tab is selected, which shows view elements designed to present details of one or more business partners. However, in the example of FIG. 7A, since no business partner has yet been selected, these view elements are consequently not populated with customer data. View 700 provides interface functionality that facilitates the performance of a number of tasks, some of which are described in further detail below.

As discussed above, view 700 comprises a view element 703 and a view element 704, which respectively facilitate particular interactions with the business management application. In particular, view element 703 may be actuated by a user to add a new business partner, as discussed in further detail below. View element 704 includes multiple view elements that allow a user to search for a business partner for which a user may be interested in performing one or more associated tasks, as also discussed in further detail below. By providing details of a business partner to the text fields in view element 704, data relating to that business partner may be retrieved, viewed and/or edited using the management interface.

FIG. 7B depicts view 700, in which view element 702 has been hidden and view element 711, which presents address data relating to a business partner, is made visible by selecting the “Addresses” tab (e.g., via a user actuating the tab labeled “Addresses” in view element 702 to instruct the interface to make visible the data and interface elements organized under this tab and hiding from view the information organized under the “Basic Data” tab). As described above, view elements presented via a single view, namely view 700, do not require the management interface to communicate with the business management application to display the combination of view elements shown in FIG. 7B and/or any data that has been collected for the view. However, in some embodiments, the management interface may make an asynchronous call to the business management application, for example, to determine whether data has been modified, and if so to obtain updated data from the business management application.

Additionally, the presentation in FIG. 7B may be arrived at in response to the user indicating the desire to create a new business partner (e.g., by actuating view element 703 presented as shown in FIG. 7A). In FIG. 7B, the user has begun to create a new business partner, and consequently the button 703 shown in FIG. 7A has been replaced with view element 712, which, when actuated, will save the changes made by the user. View element 713, when actuated, allows a user to discard those changes. In this example, the user actuates view element 712 to save the changes to the business partner (e.g., the addition of the address “123 Pine St, Chicago, Ill. 60614, US”), which results in data exchange with the business management application being performed to commit these changes (e.g., to a database associated with the business management application). If the “Addresses” tab of view 700 had been selected in connection with an existing customer specified by the user, the view elements illustrated in FIG. 7B would have been populated with the corresponding customer data obtained via a set of accesses performed to obtain the collection of data associated with view 700.

FIG. 7C illustrates a screen shot after the user has selected the “ID Numbers” tab, which allows the user to view different identification number associated with a business partner, for example, the new business partner created. The management interface, when initiating actions to save the new business partner (e.g., via the user actuating view element 712) may retrieve the Partner ID number assigned to the business partner, as shown in view element 722 (i.e., value “0010001199”). FIG. 7C illustrates a continuation of the process in which the user adds further information in association with the new business partner, entering a new ID Number and Tax Number via the view elements provided in view element 721.

It should be appreciated that if the user had requested customer data associated with an existing business partner (e.g., using the search view element 704 shown in FIG. 7A), any corresponding number available would be automatically populated and presented in the view when the “ID Numbers” tab is selected. As discuss above, when a user identifies a particular business partner, most or all of the customer data needed to populate the various view elements forming view 700 may be obtained in a single set of accesses to the business management application so that it is immediately available as the user interacts with the exemplary view elements of view 700.

FIG. 7D illustrates a screen shot resulting from the user actuating the “Account Balance” tab, which presents account data associated with the business partner (e.g., an Accounts Balance Overview presentation and an Accounts Balance Details presentation). As the screen shot in FIG. 7D is a newly created business partner there may be no relevant data yet to display in this respect. However, as shown in a subsequent screen shot described below in connection with FIG. 7G, the added account data may be displayed pursuant to the user specifying a contract or policy for the business partner. Additionally, account data associated with an existing business partner selected by the user may be presented immediately when the “Accounts Balance” tab is selected since when a user specifies an existing business partner, this customer data may be obtained to populate the view. In the example shown in FIG. 7D, the user is preparing to create a new contract for the new business partner, which may be performed by actuating view element 732 (which the mouse pointer is hovering over in FIG. 7D).

In FIG. 7E, the user has actuated view element 732 and view element 741 has been presented in the form of a separate window that appears to allow a user to add, view and/or modify contract details. View element 741 may include a number of additional view elements including text boxes and drop-down menus to allow the user to specify a policy (e.g., a payment policy) for the newly created business partner. For example, the user may enter information regarding the contract by actuating the text field labeled “Type.” In the example of FIG. 7E, view element 742 is shown as a drop-down list when the “Type” text field is actuated (e.g., when a user clicks in the text field) to provide the user with a list of valid values that may be entered into the “Type” field (namely, “CL,” “GP,” or “SB”). As discussed above, certain data may be cached to allow the data to be immediately presented without further accessing the business management application. In this case, the contract “types” may be cached so that the drop-down menu may be quickly presented, appearing as instantaneous to the user in many instances. Thus, the new contract details may be added quickly and conveniently. Again, if the user had selected an existing business partner and chosen an existing contract from those displayed (or identified by number), the contract details would have been automatically populated and, in embodiments where such information is presented in a single view, populated without further access to the business management application subsequent to the accesses responsive to the user selecting a particular business partner.

In FIG. 7F, the user has completed the contract form and may save the new contract by actuating the view element depicting a disk, denoting that the function of the view element is to save entered data. In FIG. 7G, the data entered for the new business partner have been save and view element 761 has been presented, which includes account data associate with the new contract submitted to the business management application. In particular, the “Account Balance Overview” and “Account Balance Details” that contained no meaningful data before the contract was added, are now populated with the account information corresponding to the added contract.

As discussed above, the view presented in FIG. 7A by a management interface includes search view element 704, which may be used to perform a search for a particular business partner. Such functionality may be useful, for example, when a user of the management interface wishes to inspect account information corresponding to the business partner, edit one or more data fields associated with the business partner, perform one or more tasks associated with the business partner, or otherwise manually intervene in connection with the business partner's account managed by a business management application.

FIGS. 7H-I illustrate an exemplary process of searching for a business partner such that business and/or customer data made be obtained for the business partner and presented in a single consolidated view (e.g., view 700). View 700 as presented in FIG. 7H includes search view element 771 which, when actuated, displays view element 772 comprising a number of view elements into which search terms may be entered to facilitate a search for a desired business partner (e.g., by last name, first name, keyword, etc.). View element 772 also includes a tab “By Address” that allows a user to search for a business partner using address, other demographic information or other desired criteria. In the example of FIG. 7H, the tab “By Name” has been shown and within it, a name “GILMAN” has been entered into a text field of view element 773.

Results of the search for the name “GILMAN” may be performed automatically (e.g., by asynchronously providing a query to a business management application based on search term(s)), and/or may be performed in response to user action (e.g., in response to a user hitting “Enter” on a keyboard or in response to a user clicking on a view element associated with executing a search). In the example of FIG. 7H, two results of a search for the name “GILMAN” are displayed in view element 774. A user of the management interface may select one of the search results, e.g., by clicking on the search result in view element 774, to load the corresponding business partner's data can be obtained and presented in a single view of the management interface. In the present example, a user of the management interface clicked on the search result for “JON GILMAN” shown in view element 774, which results in data associated with this business partner being displayed in view element 781 as shown in FIG. 7I.

In the example of FIG. 7I, data associated with the selected business partner, including first name and last name, is displayed. In addition, the business partner's unique identification value is shown in view element 782 (“0010000007” in this example). It should be appreciated that, as discussed above, the numerous tabs provided within view 700 (i.e., “Basic Data,” “Addresses,” “ID Numbers,” etc.) may each be populated with data relating to the customer with unique identification value of “0010000007” in the example of FIG. 7I. Data relating to this business partner may have been retrieved from a business management application as part of the same query in which the first name and last name were retrieved, allowing a user to click on the “Account Balance” tab, for example, and see the account balances for the user (as illustrated in FIG. 7D and discussed above) without further access to the business management application being required. Accordingly, the user may perform one or more tasks associated with the selected business partner in an efficient and intuitive manner.

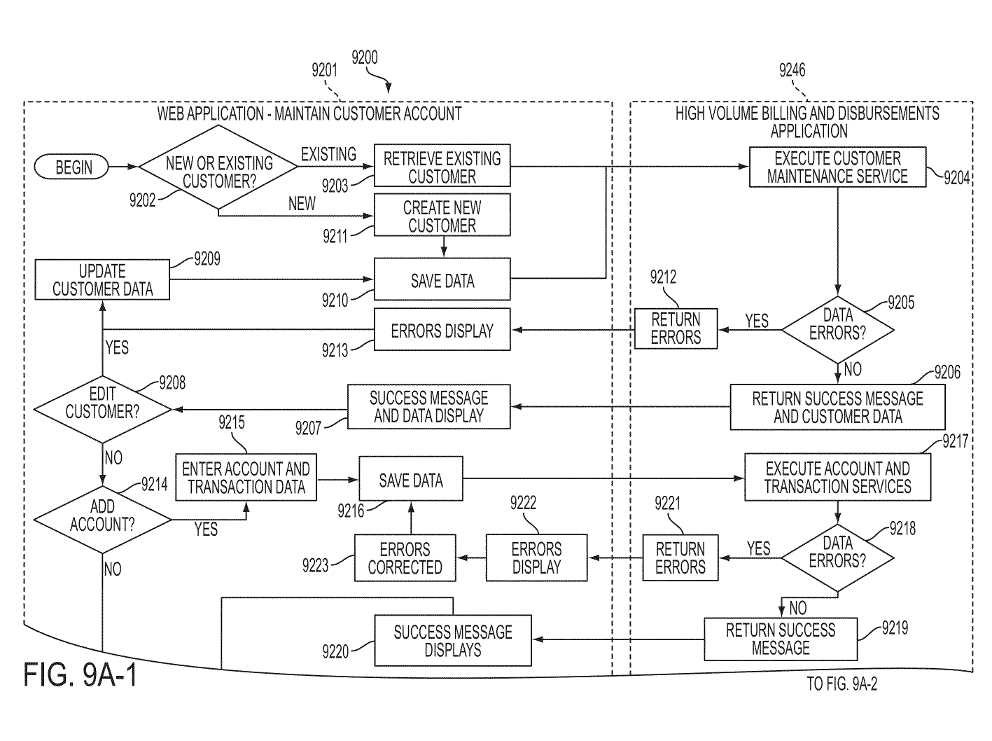

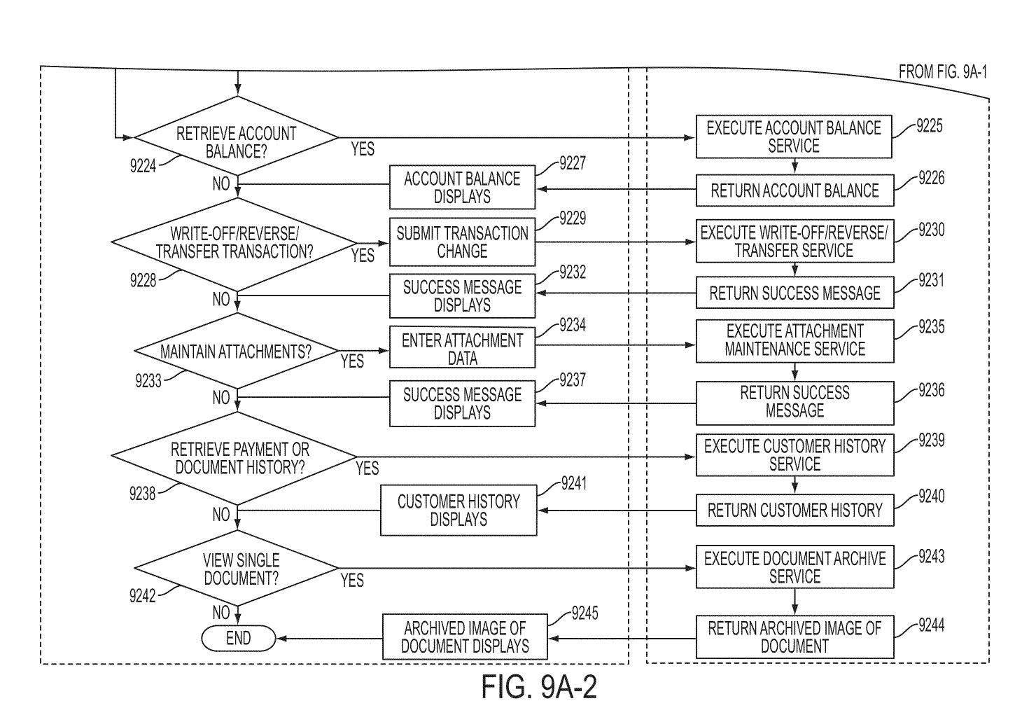

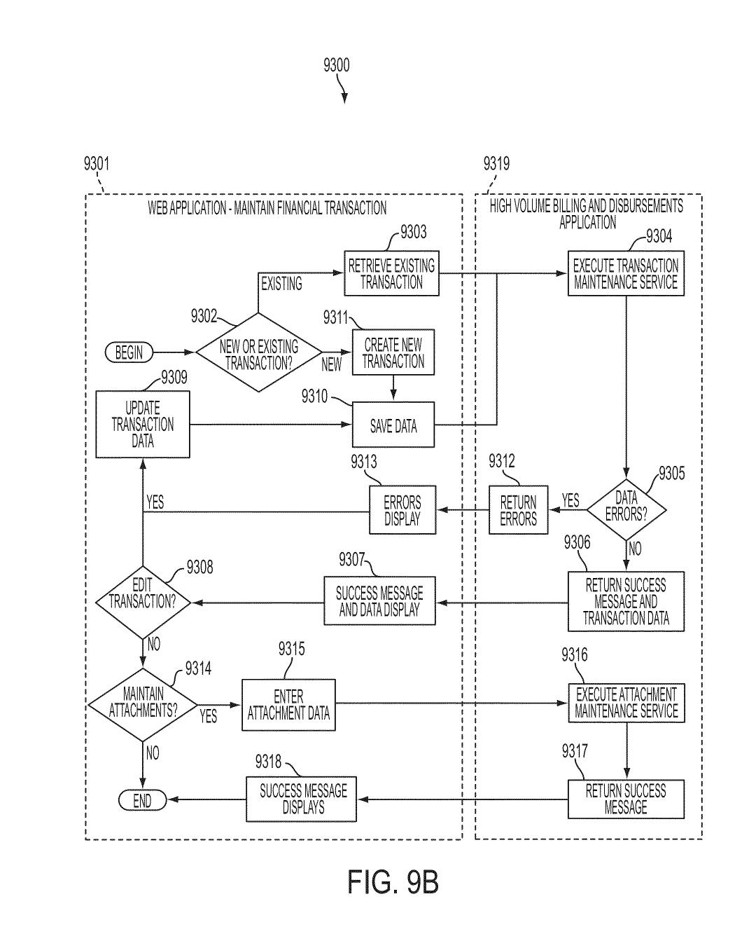

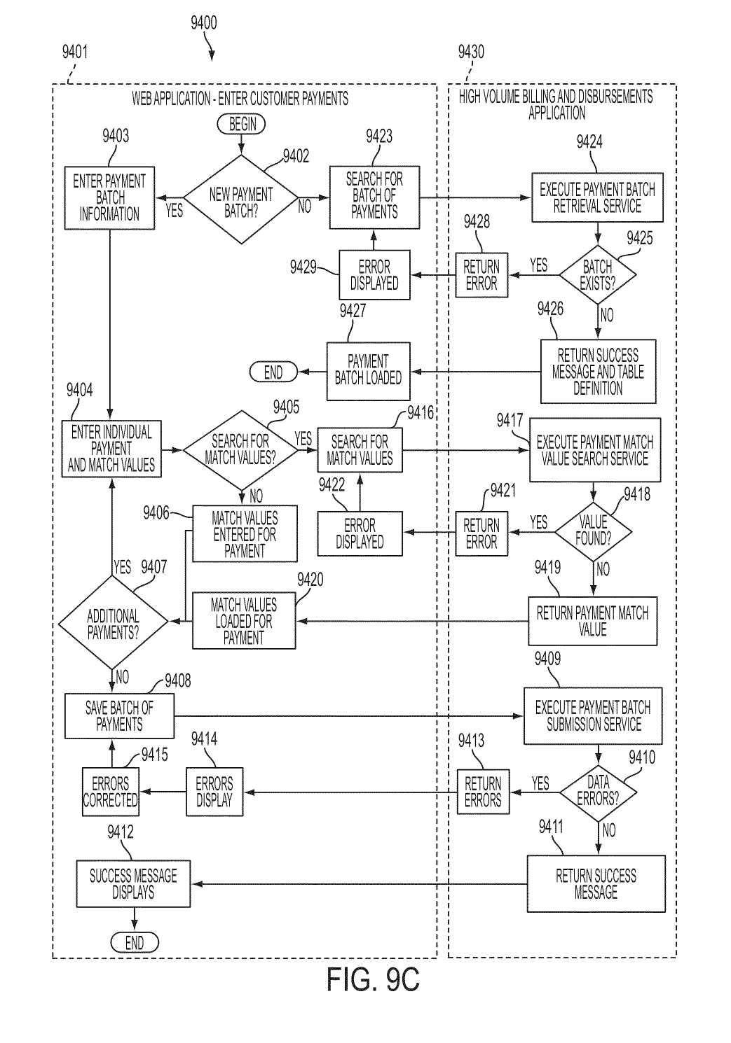

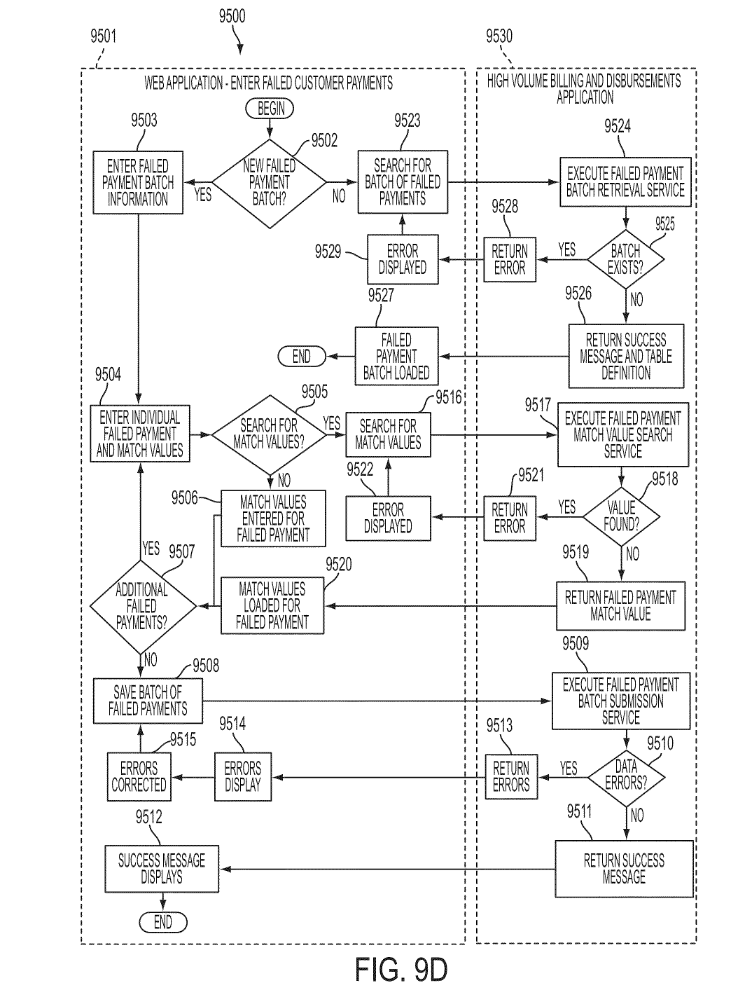

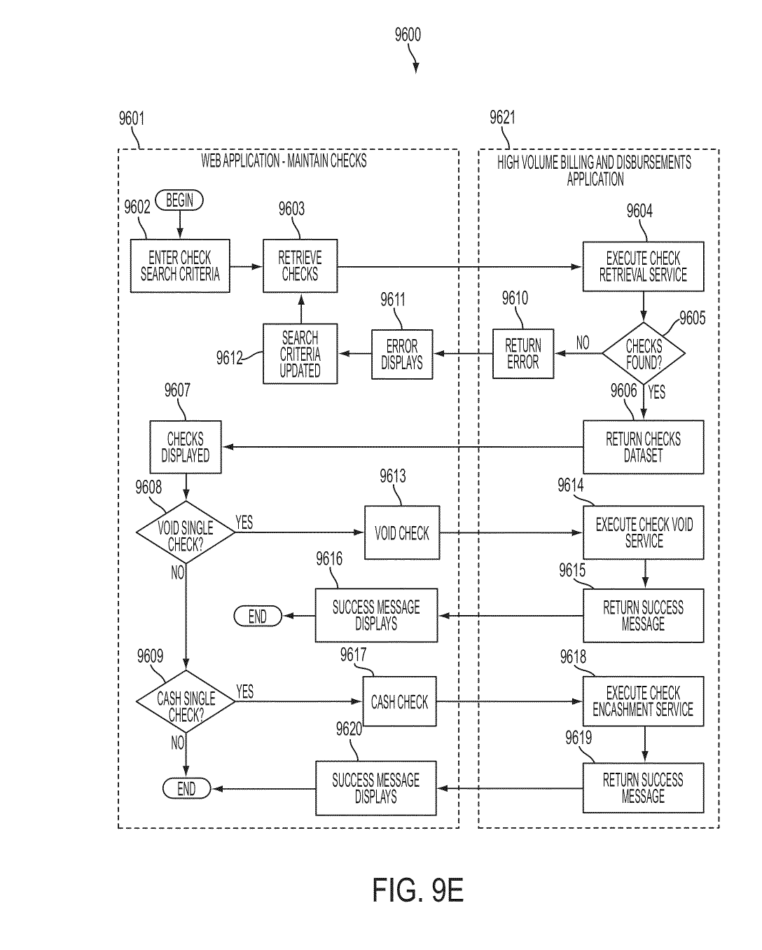

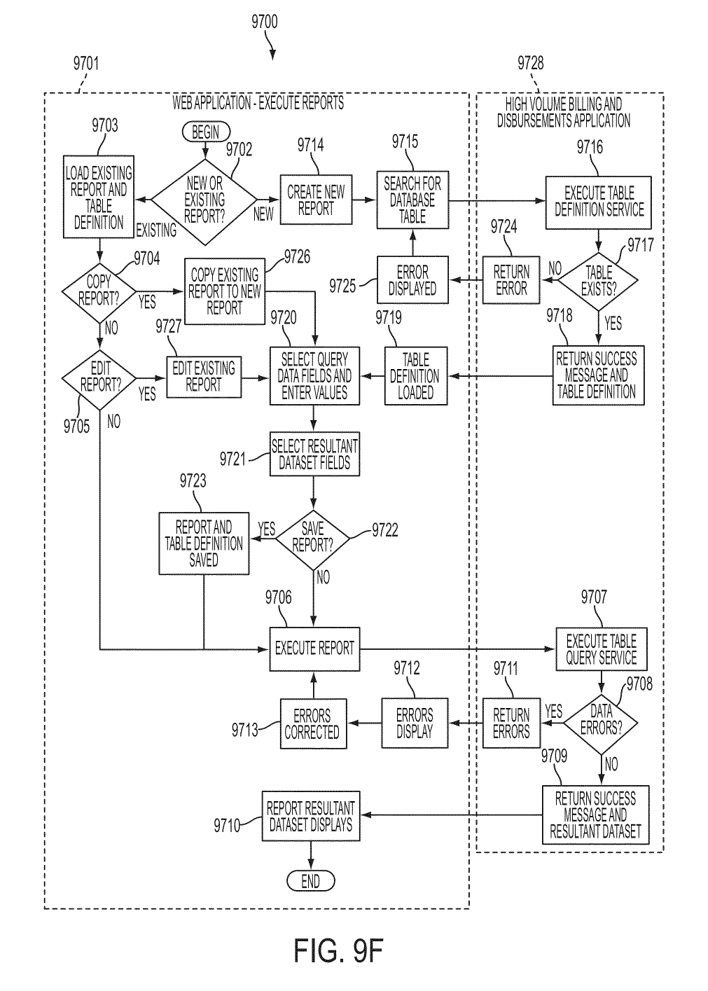

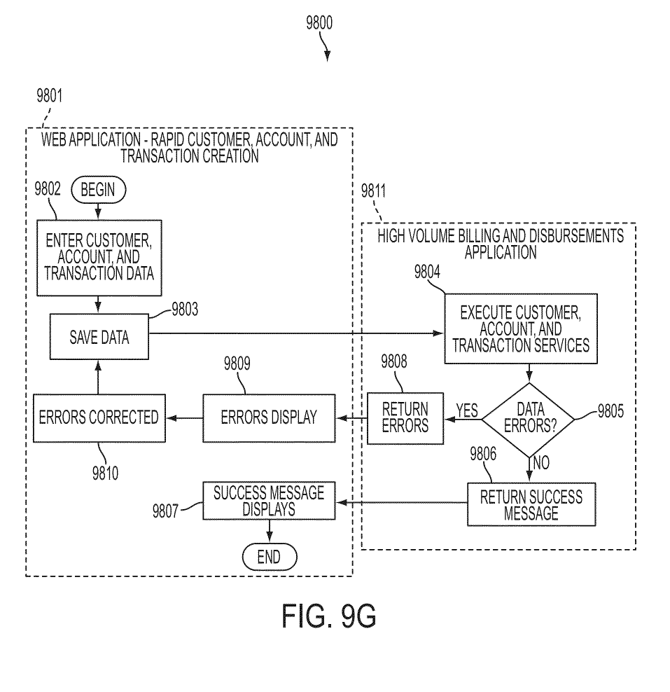

As discussed above, a view may present business and/or customer data and the accompanying interface elements to allow a user to perform a multiplicity of tasks. FIG. 9A illustrates a flow chart of exemplary tasks that may be performed using the “Business Partner” link presented in the navigation view element 701 shown in the screen shot illustrated in FIG. 7A, some of which correspond generally with task described in the foregoing. The process described in association with FIG. 9A may be performed, for example, in connection with a high volume billing and disbursement application. For example, a user actuating the “Business Partner” link depicted in FIG. 7A may create a new customer (as indicated above, the term “Business Partner” as used herein is synonymous with a customer), edit details relating to an existing customer, add a new account for a customer and/or perform other tasks associated with the selected business partner.

In the example of FIG. 9A, acts performed by a web application (e.g., such the management interface and an associated management interface application) in the processes described are depicted in the dotted box denoted 9201, and acts performed by a business management application represented in this embodiment by a high volume billing and disbursements application are depicted in the dotted box 9246. In exemplary process 9200, a user can elect to view an existing customer or create a new customer (9202). If data relating to an existing customer is desired, the user may enter search parameters and execute the service to retrieve the customer (9203), which establishes a connection with the high volume billing and disbursements system to execute the customer maintenance service (9204). If data errors have occurred (9205), the errors are returned to the web application (9212) and displayed to the user (9213) who can correct the errors and execute the retrieval of customer data again. If no errors have occurred (9205), a success message and the customer data are returned (9206) to the web application and displayed to the user (9207). The user can then elect to edit customer data (9208) and begin updating the desired customer information (9209) before saving the data (9210).

Alternatively, or additionally, upon loading of the interface, a user could also create a new customer and enter the appropriate customer data (9211) before saving the data (9210). Upon saving, a connection to the high volume billing and disbursements system is made and the same customer maintenance service (9204) is executed. If data errors have occurred (9205), the errors are returned to the web application (9212) and displayed to the user (9213). In this case, the user may then update the customer data (9209) and attempt to save the data again (9210).

A user may alternatively, or additionally, within the example process illustrated in FIG. 9A, add a new account to the customer (9214), in which case the user would enter basic account and transaction data (9215) before saving (9216). The save would again establish a connection to the high volume billing and disbursements system to execute account and transaction maintenance services (9217). If data errors have occurred (9218), the errors are returned to the web application (9221) and displayed to the user (9222) who can correct the errors (9223) and save the data again. If no errors have occurred (9218), a success message is displayed to the user (9220) via the management interface.

A user may alternatively, or additionally, within the example process shown in FIG. 9A, retrieve a customer's account balance (9224). When the account balance is requested a connection is established to the high volume billing and disbursements system to execute the account balance service (9225). The service returns the customer's account balance (9226) and transaction history to the web application, where it is displayed to the user (9227) via the management interface.

A user may alternatively, or additionally, within the example process shown in FIG. 9A, write-off, reverse, or transfer a transaction on a customer's account balance (9228). A user may select a transaction and an appropriate action to submit the change (9229), which establishes a connection to the high volume billing and disbursements system to execute a service that can write-off, reverse or transfer the selected transaction (9230). The service returns a success message (9231) to the web application where it is displayed to the user (9232) via the management interface.

A user may alternatively, or additionally, within the example process illustrated in FIG. 9A, maintain a list of attachments on the customer (9233). A user may edit an existing attachment and/or create a new attachment (9234) before saving, which establishes a connection to the high volume billing and disbursements system to execute an attachment maintenance service (9235). The service returns a success message (9236) to the web application where it is displayed to the user (9237) via the management interface.

A user may alternatively, or additionally, within the example process illustrated in FIG. 9A, retrieve a history of all payments made by a customer and a history of all documents sent to the customer (9238). When the history is requested a connection is established to the high volume billing and disbursements system to execute the customer history service (9239). The service returns the customer history (9240) to the web application, where it is displayed to the user (9241) via the management interface.

A user may alternatively, or additionally, within the example process illustrated in FIG. 9A, click on a single entry in the history of documents sent to the customer (9242). This action causes a connection to be established to the high volume billing and disbursements system to execute the document archive service (9243), which retrieves a physical image of the document and returns the image to the web application (9244) where it is displayed to the user in a pop-up window (9245).

It should be appreciated that the tasks described in the foregoing are merely exemplary and more or different functionality may be made available via the management interface in connection with a business partner view of the like. View element 701 of exemplary view 700 includes a number of links in addition to the “Business Partner” link. In particular, view element 701 includes a “Contract Account” link providing access to interface functionality for viewing and/or editing (creating, editing and/or deleting) data associated with one or more contract accounts associated with one or more customer accounts managed by the business management application. A contract account may, for example, be associated with multiple policies, for example, insurance policies for a management interface designed to interact with a billing and disbursement application for an insurance company. In this respect, view element 701 of exemplary view 700 also includes an “Insurance Object” link providing a process for viewing and/or editing insurance objects (e.g., insurance policies) associated with one or more business partners and/or contract accounts.

View element 701 of exemplary view 700 also includes a “Document” link providing interface functionality for viewing and/or editing documents (e.g., financial documents), which may be data associated with a particular business partner, contract account and/or data object. For example, a payment made by a particular business partner relating to a contract and data object associated with that business partner. FIG. 9B illustrates a flow chart of processes associated with the “Document” link, which may present one or more views to the user via the management interface to, for example, allow the user to create a transaction, edit a transaction and/or update associated transaction data. In the example process illustrated in FIG. 9B, acts enclosed in the dotted box denoted by 9301 are performed by a web application (e.g., the management interface and corresponding management interface application), and acts enclosed in the dotted box denoted by 9319 are performed by a business management application represented in some embodiments by a high volume billing and disbursements application.

In the example process 9300, a user may choose to create a new financial transaction and/or to edit an existing financial transaction (9302). If an existing transaction is desired, the user may enter search parameters to execute the service to retrieve the transaction (9303), which establishes a connection with the high volume billing and disbursements system (9319) to execute the transaction maintenance service (9304). If no data errors have occurred (9305), the transaction data is returned (9306) to the web application and displayed to the user (9307). If data errors have occurred, the errors are returned (9312) to the web application and displayed to the user (9313). Once the user has retrieved the transaction, the user can elect to edit the transaction (9308). The data on the transaction may be updated by the user (9309) before saving the data (9310), which establishes a connection with the high volume billing and disbursements system (9319) to again execute the transaction maintenance service (9304). Alternatively or additionally, a user can create a new financial transaction (9311) and enter all data before saving (9310) to again trigger the transaction maintenance service.

A user may alternatively, or additionally, within the example process illustrated in FIG. 9B, maintain a list of attachments on the document (9314). A user may edit an existing attachment and/or create a new attachment (9315) before saving, which establishes a connection to the high volume billing and disbursements system to execute an attachment maintenance service (9316). The service returns a success message (9317) to the web application where it is displayed to the user (9318). Other tasks may be performed in connection with one or more document views, as the above tasks are merely exemplary in number and kind.

View element 701 of exemplary view 700 also includes an “Incoming Payments” link providing a process for manually entering payments, which may be beneficial for example, when a business partner wishes to pay at a location of the business for which the management application is serving (e.g., pay in cash), or a business partner wishes to pay in a manner that cannot be accomplished using the modes handled by the automated tasks managed by the business management application (e.g., billing and disbursements management application). FIG. 9C illustrates a flow chart of processes associated with the “Incoming Payments” link, which may present one or more views to the user via the management interface to, for example, allow the user to enter payment information manually, either individually and/or in a batch mode. In the example process illustrated in FIG. 9C, acts enclosed in the dotted box denoted by 9401 are performed by a web application (e.g., the management interface and corresponding management interface application), and acts enclosed in the dotted box denoted by 9430 are performed by a business management application represented by a high volume billing and disbursements application.

In example processes 9400, a user may create a new batch of payments and/or retrieve an existing batch (9402). If the user elects to create a new batch, basic header information is entered (9403) before entering detailed information (9404) for each payment. If the user already knows the appropriate match values (9405) that will be used to match the payment to a receivable, such as invoice number, customer number, etc., the data may be entered with the payment (9406). If the user does not know the match values, search parameters (9416) may be entered and a connection established to the high volume billing and disbursements system (9430) to execute a payment match value search (9417). If the match value is found (9418), the value is returned (9419) to the web application and loaded to the single payment (9420). If the match value is not found (9418), an error is returned (9421) to the web application and displayed to the user (9422), who can then make another attempt to find a match value.

The user can then continue to enter payments (9407) before saving the batch of payments (9408), which establishes a connection to the high volume billing and disbursements system (9430) to execute a payment batch submission service (9409). If no data errors have occurred (9410), a success message is returned (9411) to the web application and displayed to the user (9412). If errors have occurred (9410), the errors are returned (9413) to the web application and displayed to the user (9414), who can then correct the errors (9415) and submit the payment batch again.

A user may alternatively, or additionally, within the example process illustrated in FIG. 9C, elect to view an existing batch of payments (9402). The user may enter search criteria for the payment batch (9423) which establishes a connection to the high volume billing and disbursements system (9430) to execute a payment batch retrieval service (9424). If the payment batch exists (9425), the batch is returned (9426) to the web application and displayed to the user (9427). If the payment batch does not exist (9425), an error is returned (9428) to the web application and displayed to the user (9429), who can then correct search parameters and attempt the search again. Other tasks may be performed in connection with one or more incoming payment views, as the above tasks are merely exemplary.

View element 701 of exemplary view 700 also includes a “Returned Payments” link providing a process for correcting an issue with a transaction, for example, to handle the circumstance in which a payment is returned by the bank processing the payment. FIG. 9D illustrates a flow chart of processes associated with the “Returned Payments” link, which may present one or more views to the user via the management interface to, for example, allow the user to enter failed payment information individually and/or in a batch mode. In the example process illustrated in FIG. 9D, acts enclosed in the dotted box denoted by 9501 are performed by a web application (e.g., the management interface and corresponding management interface application), and acts enclosed in the dotted box denoted by 9530 are performed by a business management application represented in this embodiment by a high volume billing and disbursements application.

In example process 9500, a user can create a new batch of failed payments and/or retrieve an existing batch (9502). If the user elects to create a new batch, basic header information may be entered (9503) before entering detailed information (9504) for each failed payment. If the user already knows the match values (9505) that will be used to match the failed payment to the original payment, such as check number, ACH trace number, etc., the data is entered with the failed payment (9506). If the user does not know the match values, search parameters (9516) may be entered and a connection established to the high volume billing and disbursements system 9530 to execute a failed payment match value search (9517). If the match value is found (9518), the value is returned (9519) to the web application and loaded to the single failed payment (9520). If the match value is not found (9518), an error is returned (9521) to the web application and displayed to the user 9522, who can then make another attempt to find a match value.

The user can then continue to enter failed payments (9507) before saving the batch of failed payments (9508), which establishes a connection to the high volume billing and disbursements system (9530) to execute a failed payment batch submission service (9509). If no data errors have occurred (9510), a success message is returned (9511) to the web application and displayed to the user (9512). If errors have occurred (9510), the errors are returned (9513) to the web application and displayed to the user (9514), who can then correct the errors (9515) and submit the failed payment batch again.

A user may alternatively, or additionally, within the example process illustrated in FIG. 9D, elect to view an existing batch of failed payments (9502). The user may enter search criteria for the failed payment batch (9523) which establishes a connection to the high volume billing and disbursements system (9530) to execute a failed payment batch retrieval service (9524). If the failed payment batch exists (9525), the batch is returned (9526) to the web application and displayed to the user (9527). If the failed payment batch does not exist (9525), an error is returned (9528) to the web application and displayed to the user (9529), who can then correct search parameters and attempt the search again. Other tasks may be performed in connection with one or more returned payment views, as the above tasks are merely exemplary.

View element 701 of exemplary view 700 also includes an “Invoice Reconciliation” link providing a process for reconciling contracts associated with a business partner. For example if the business partner is an employer that provides insurance to its employees, the business partner may be associated with many contracts and insurance objects, and it may therefore be beneficial to perform bulk operations on these objects (e.g., remove contracts for recently-departed employees).

View element 701 of exemplary view 700 also includes a “Check Management” link providing a process for voiding and/or reissuing checks to a business partner. FIG. 9E illustrates a flow chart of processes associated with the “Check Management” link, which may present one or more views to the user via the management interface to, for example, allow the user to search for check data, void a check and/or cash a check. In the example process illustrated in FIG. 9E, acts enclosed in the dotted box denoted by 9601 are performed by a web application (e.g., the management interface and corresponding management interface application), and acts enclosed in the dotted box denoted by 9621 are performed by a business management application represented in this embodiment by a high volume billing and disbursements application.

In example processes 9600, a user may enter search criteria (9602) to retrieve desired checks (9603), which may then establish a connection to the high volume billing and disbursements system (9621) and execute the check retrieval service (9604). If the checks are found (9605) the resultant dataset is returned (9606) to the web application and displayed to the user (9607). If the checks are not found an error is returned (9610) to the web application and displayed to the user (9611), who can then correct the search criteria (9612) and submit the search again.

Once the checks have been displayed (9607), the user can analyze the data, void a single selected check (9608), and/or cash a single selected check (9609). If the user elects to void a check (9613), a connection is established to the high volume billing and disbursements system (9621) and the check voiding service is executed (9614). A success message is then returned (9615) to the web application and displayed to the user (9616). If the user elects to cash a check (9617), a connection is established to the high volume billing and disbursements system (9621) and the check cashing service is executed (9618). A success message is then returned (9619) to the web application and displayed to the user (9620). Other tasks may be performed in connection with one or more check management views, as the above tasks are merely exemplary.

View element 701 of exemplary view 700 also includes a “Reports” link providing a process for generating custom reports. In addition, the management interface may be configured to allow a user to generate a report from any table or other presentation provided via the interface (e.g., exported to excel) and/or may allow a report to be generated from any table stored by a database associated with the business management application. FIG. 9F illustrates a flow chart of processes associated with the “Reports” link, which may present one or more views to the user via the management interface to, for example, allow the user to create, copy and/or edit reports. In the example process illustrated in FIG. 9F, acts enclosed in the dotted box denoted by 9701 are performed by a web application (e.g., the management interface and corresponding management interface application), and acts enclosed in the dotted box denoted by 9728 are performed by a business management application represented in this embodiment by a high volume billing and disbursements application.

In example processes 9700, a user can choose to create a new report and/or load an existing report (9702). If an existing report is desired, the user selects the report from a list and the report and database table definition are loaded from the web application (9703). A user can then elect to copy the report (9704), edit the report (9705), or simply execute the report (9706). Upon executing the report, a connection is established to the high volume billing and disbursements system (9728) to execute the database table query service (9707). If no data errors have occurred (9708), a dataset included in a response to the query is returned (9709) to the web application where it is displayed to the user (9710). If data errors have occurred (9708), the errors are returned (9711) to the web application where they are displayed to the user (9712). The errors can be corrected (9713) and the report and be executed again (9706).

If the user elects to copy the report (9704), the database table definition and report parameters are copied to a new report (9726). The user may then select new query parameters or modify existing query parameters (9720) before saving (9722) the report to the web application (9723) and executing the report (9706). If the user elects to edit the report (9705), the report's definition becomes editable (9727). The user may then select new query parameters or modify existing query parameters (9720) before saving (9722) the report to the web application (9723) and executing the report (9706).

If the user elects to create a new report (9714), the user may search for a database table (9715), which establishes a connection to the high volume billing and disbursements system (9728) and executes the table definition service (9716). If the table does not exist (9724) an error is returned to the web application and displayed to the user (9725), and the user can attempt the search again. If the table does exist (9717), the database table's definition is returned (9718) to the web application and displayed to the user (9719). From here the user can select query parameters as already described (9720) and execute the report (9706). Other tasks may be performed in connection with one or more reports views, as the above tasks are merely exemplary.

View element 701 of exemplary view 700 also includes a “Time Saver” link providing a process for creating a business partner, contract and transactions at the same time efficiently. FIG. 9G illustrates a flow chart of processes associated with the “Time Saver” link, which may present one or more views to the user via the management interface to, for example, allow the user to quickly and easily enter customer, account and transaction data, for example, in a single convenient process and/or view. In the example process illustrated in FIG. 9G, acts enclosed in the dotted box denoted by 9801 are performed by a web application (e.g., the management interface and corresponding management interface application), and acts enclosed in the dotted box denoted by 9811 are performed by a business management application represented in this embodiment by a high volume billing and disbursements application.

In example process 9800, a user may enter relevant customer, account, and transaction data (9802) and then save the data (9803). A connection is established with the high volume billing and disbursements system (9811) and the customer, account, and transaction maintenance services are executed (9804). If no data errors have occurred (9805), a success message is returned (9806) to the web application and displayed to the user (9807). If data errors have occurred (9805), the errors are returned (9808) to the web application and displayed to the user (9809). The user can then correct the errors (9810) and save the data again (9803). Other tasks may be performed in connection with one or more time saver views, as the above tasks are merely exemplary.

Having herein described several embodiments, several advantages of embodiments of techniques described in the present application should be apparent. One advantage is that embodiments may provide an efficient and convenient management interface presented using commonly understood technology.

While aspects of the management interface presented herein are discussed in terms of particular business applications, it should be appreciated that aspects of the management interface presented herein may be applied to any suitable business use case. A non-limiting list of suitable business use cases includes: insurance, banking, online shopping and/or auctions, sales and marketing, telecommunications, government (e.g., taxes), and/or any combination thereof.

Moreover, while aspects of the management interface presented herein are discussed in terms of particular business software, it should be appreciated that aspects of the management interface presented herein are not limited to use with any particular software, and may be used with any suitable software. A non-limiting list of software that may be used in conjunction with aspects of the management interface described herein include: SAP (e.g., SAP ERP), Oracle (e.g., Oracle E-Business Suite, PeopleSoft), Salesforce, Microsoft Dynamics, and combinations thereof.

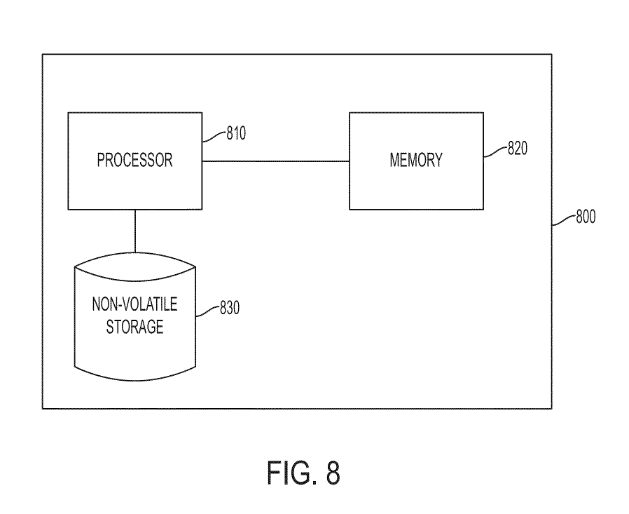

An illustrative implementation of a computer system 800 that may be used to implement one or more of the management interface techniques described herein is shown in FIG. 8. The computer system 800 may include one or more processors 810 and one or more non-transitory computer-readable storage media (e.g., memory 820 and one or more non-volatile storage media 830). The processor 810 may control writing data to and reading data from the memory 820 and the non-volatile storage device 830 in any suitable manner, as the aspects of the invention described herein are not limited in this respect. To perform functionality and/or techniques described herein, the processor 810 may execute one or more instructions stored in one or more computer-readable storage media (e.g., the memory 820, storage media, etc.), which may serve as non-transitory computer-readable storage media storing instructions for execution by the processor 810.

In connection with the management interface techniques described herein, code used to generate one or more management interfaces may be stored on one or more computer-readable storage media of computer system 800. In addition, code capable of performing communication with one or more business management applications may also be stored on computer system 800. Processor 810 may execute the management interface such that management interface is presented to a user. Any other software, programs or instructions described herein may also be stored and executed by computer system 800.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of providing access to and presenting information from a third-party business management software system, the third-party business management software system comprising a database storing customer data for a plurality of customers, the method comprising:
providing an interface for display on a user computer, the interface accessible via an internet browser coupled to a network;
receiving input from a user via the interface identifying a customer from the plurality of customers;
responsive to the input from the user, accessing the third-party business management software system to obtain customer data associated with the identified customer; and
presenting the customer data to the user via the interface in a single view.

2. The method of claim 1, wherein the customer data includes demographic data and account data.

3. The method of claim 2, wherein the demographic data includes name data, address data and contact data associated with the identified customer.

4. The method of claim 2, wherein the customer data further comprises account status data and contract data associated with the account data.

5. The method of claim 2, wherein the single view further presents links corresponding to a set of processes capable of being performed on the customer and/or the customer data such that when the user selects a link, the corresponding process can be performed.

6. The method of claim 5, wherein the third-party business management software system is configured to perform a plurality of automated tasks in association with the plurality of customers and corresponding customer data, and wherein the set of processes correspond to processes requiring manual manipulation of the customer data.

7. The method of claim 6, wherein the third-party business management software system is a billing management software system for automating collections and disbursements, and wherein the set of processes includes at least two of business partner processing, document history, incoming payment processing, returned payment processing, check management and reporting.

8. The method of claim 1, further comprising:
requesting access permissions from the user;
receiving access permissions from the user; and
authenticating access permissions received from the user against access permissions of the third-party business management software system for the user.

9. The method of claim 8, wherein the access permissions grant access to a set of authorization objects associated with the third-party business management software system, the method further comprising:
presenting an authorization update control on the interface that, when actuated by the user, updates the set of authorization objects to reflect any added or deleted authorization objects associated with the access permissions.

10. The method of claim 1, further comprising:
obtaining data from the third-party business management software system;
caching the obtained data;
responsive to an input from the user associated with a first view element, obtaining the obtained data from the cache; and
presenting at least a subset of the obtained data to the user via the interface without accessing the third-party business management software system in response to the user.

11. The method of claim 10, further comprising receiving input from a user responsive to the presenting of at least a subset of the obtained data such that one or more values of the obtained data become associated with the first view element.

12. A system for providing access to and presenting information from a third-party business management software system on a user computer connected to a network, the third-party business management software system comprising a database storing customer data for a plurality of customers, the system comprising:
at least one application computer capable of communicating with the user computer over the network, the at least one application computer executing an application configured to communicate with the third-party business management software system, the application, when executed by the at least one application computer, causing the at least one application computer to perform:
providing an interface for display on the user computer, the interface accessible via an internet browser coupled to the network;
receiving input from the user via the interface identifying a customer from the plurality of customers;
responsive to the input from the user, accessing the third-party business management software system to obtain customer data associated with the identified customer; and
presenting the customer data to the user via the interface in a single view.

13. The system of claim 12, wherein the customer data comprises demographic data and account data.

14. The system of claim 13, wherein the demographic data includes name data, address data and contact data associated with the identified customer.

15. The system of claim 13, wherein the customer data further comprises account status data and contract data associated with the account data.

16. The system of claim 13, wherein the single view further presents links corresponding to a set of processes capable of being performed on the customer and/or the customer data such that when the user selects a link, the corresponding process can be performed.

17. The system of claim 16, wherein the third-party business management software system is configured to perform a plurality of automated tasks in association with the plurality of customers and corresponding customer data, and wherein the set of processes correspond to processes requiring manual manipulation of the customer data.

18. The system of claim 17, wherein the third-party business management software system is a billing management software system for automating collections and disbursements, and wherein the set of processes includes at least two of business partner processing, document history, incoming payment processing, returned payment processing, check management and reporting.

19. The system of claim 12, wherein the at least one application computer further performs:
requesting access permissions from the user;
receiving access permissions from the user; and
authenticating access permissions received from the user against access permissions of the third-party business management software system for the user.

20. The system of claim 19, wherein the access permissions grant access to a set of authorization objects associated with the third-party business management software system, and wherein the at least one application computer further performs:
presenting an authorization update control on the interface that, when actuated by the user, updates the set of authorization objects to reflect any added or deleted authorization objects associated with the access permissions.

21. The system of claim 12, wherein the at least one application computer further performs:
obtaining data from the third-party business management software system;
caching the obtained data;
responsive to an input from the user associated with a first view element, obtaining the obtained data from the cache; and
presenting at least a subset of the obtained data to the user via the interface without accessing the third-party business management software system in response to the user.

22. The system of claim 21, wherein the at least one application computer further performs:
receiving input from a user responsive to the presenting of at least a subset of the obtained data such that one or more values of the obtained data become associated with the first view element.
